(19) United States
(12) Patent Application Publication
(10) Pub. No.: US 2026/0221666 A1
(43) Pub. Date: Jul. 30, 2026

(54) SYSTEM AND METHOD FOR A VIRTUAL LINE-OF-SIGHT WITH A NON-VOLATILE RECONFIGURABLE METASURFACE FOR WI-FI SENSING

(71) Applicant: Dell Products LP, Round Rock, TX (US)

(72) Inventors: Harpreet S. Narula, Austin, TX (US); Tejinder Singh, Manotick (CA); Navjot Kaur Khaira, Manotick (CA)

(73) Assignee: Dell Products LP, Round Rock, TX (US)

(21) Appl. No.: 19/040,375

(22) Filed: Jan. 29, 2025

(51) Int. Cl. H01Q 15/00; G01S 13/534

(52) U.S. Cl. CPC H01Q 15/0086; G01S 13/534; H01Q 15/0066

(57) ABSTRACT

A system and method for operating a reconfigurable metasurface unit cell array of a virtual line-of-sight (LoS) Wi-Fi sensing system having a reconfigurable metasurface unit cell array to establish a virtual LoS portion of a Wi-Fi wireless link between a transmitter device and receiver device and a reconfigurable metasurface microcontroller unit to receive a Wi-Fi sensing request from the transmitter device. The reconfigurable metasurface microcontroller unit executes to monitor for angle of arrival and time of flight of a target object present within the virtual LoS. The reconfigurable metasurface microcontroller unit to determine a direction and location of the target object within the virtual LoS based and create a beamforming pattern at the reconfigurable metasurface to increase signal propagation of the Wi-Fi wireless link with Wi-Fi sensing to the target object and to report the direction and location of the target object to the transmitter device.

### FIELD OF THE DISCLOSURE

The present disclosure generally relates to metasurface systems for reflecting or directing radiofrequency signals used in wireless communications for information handling systems. The present disclosure more specifically relates systems and methods for a reconfigurable metasurface that operates within a Wi-Fi sense detection system to detecting target objects present within a virtual line-of-sight (LoS) communication path created by the reconfigurable metasurface to extend and direct relayed communication signals used in Wi-Fi sensing of a target object.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities that may include wireless communications. The information handling system may be used to operate a wireless interface adapter and radio system for transmission of radio signals to a receiving wireless device or access point device or to receive radio signals from the wireless device or access point device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system operating a Wi-Fi sensing system and wirelessly interfacing with a reconfigurable metasurface unit cell array according to an embodiment of the present disclosure;

FIG. 2 is a block diagram illustrating a reconfigurable metasurface unit cell array operating within a Wi-Fi sensing system according to an embodiment of the present disclosure;

FIG. 3 is a side, exploded graphic diagram illustrating a perspective view of a plurality of reconfigurable metasurface unit cells of at least part of a reconfigurable metasurface unit cell array according to an embodiment of the present disclosure;

FIG. 4 graphic diagram of a metasurface unit cell array and electromagnetic wave emission properties according to an embodiment of the present disclosure;

FIG. 5 is a graphic diagram of various emission states of a metasurface unit cell array operated by a field programmable gate array (FPGA) or other metasurface controller according to an embodiment of the present disclosure;

FIG. 6 is a graphic diagram illustrating a Wi-Fi sensing system including both Wi-Fi links between transceiving devices that may implement Wi-Fi sensing systems and Wi-Fi links between transceiving devices that may not implement Wi-Fi sensing systems according to an embodiment of the present disclosure;

FIG. 7 is a graphic diagram illustrating an environment in which the reconfigurable metasurface unit cell array may be deployed in order to create a virtual line-of-sight (LoS) extension of Wi-Fi communication links to implement a Wi-Fi sensing system according to an embodiment of the present disclosure;

FIG. 8 is a block diagram of a method of controlling a metasurface unit cell array to dynamically change the directionality and feed distance of reflected electromagnetic (EM) wave beams for radiofrequency communications according to an embodiment of the present disclosure; and

FIG. 9 is a block diagram of a method of operating a virtual LoS Wi-Fi sensing system for extension of Wi-Fi communication links and directionality via deployment of a reconfigurable metasurface unit cell array according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting device to a receiving device allows for rapid data transmission and communication between multiple devices. Devices may include wirelessly enabled information handling systems, access point devices, or any computing device, such as internet of things (IoT) devices that are wirelessly capable. As data transmission requirements increase, the electromagnetic (EM) wave (e.g., 5G technologies using 20 to 50 GHz wireless signals or WiFi signals at 2.4 GHz, 5 GHz or even 6 GHz) used to transmit these ever-increasing amounts of data are shortened or may benefit from extended range such as reach around radiofrequency barriers such as walls. However, the ability to penetrate walls and building structures as well as transmit around these relatively large structures may be limited with such wireless systems. Additionally, material properties of these buildings and other structures effect reflection from, and transmission of, EM waves through building materials and on the absorption of EM wave energy in those materials, which gives rise to attenuation of the EM signal. Other EM wave-inhibiting mechanisms include diffraction from the edges of materials and scatter from rough edges also exist in radiofrequency environments such as rooms within a building. Further, most buildings behave as lossy dielectrics as building materials as well as occasionally conductive material that further inhibit or scatter EM wave propagation.

Existing Wi-Fi sensing systems rely on line-of-sight (LoS) transmission between a transmitter and a receiver in bi-static Wi-Fi sensing detecting a distortion by an object within the LoS Wi-Fi link. In an embodiment of the present disclosure, metasurfaces are used to relay EM waves around EM wave barriers such as walls such that objects placed along or within a created virtual LoS wireless link around those walls may distort transception of data between a transmitter device and a receiver device. These objects, such as a human walking through the environment, may alter communication signals between the transmitter device and the receiver device which may be detected as Wi-Fi sensing of that object. As such, a metasurface extension of a virtual LoS wireless link and detection of objects in the extended virtual LoS wireless link path is presented in embodiments herein to inform either of the transmitter device or the receiver device that these objects are within the virtual LoS created.

In an embodiment of the present disclosure, a series of thin surfaces or panels can be installed on building surfaces or other surfaces within a radiofrequency environment that may be used to steer these EM waves and expand wireless range or signal quality of wireless links around barriers or for directionality. Some of these surfaces may include metasurface unit cells in arrays referred to as metasurface arrays in embodiments herein. Further, embodiments of the present disclosure may include reconfigurable intelligent surfaces (RISs) or “reconfigurable metasurface unit cell arrays” that include engineered materials designed to have properties not found in naturally occurring materials to allow for reconfigurability of reconfigurable metasurface unit cells in embodiments of the present disclosure. These reconfigurable metasurfaces are crafted and adjusted with a control system to manipulate EM waves in ways that non-reconfigurable metasurface unit cells cannot, thereby often achieving effects like negative refraction as well as control over directionality of reflection and redirection of EM waves of the radiofrequency signals.

The present specification describes a reconfigurable metasurface unit cell array of a virtual line-of-sight (LoS) WiFi sensing system. The reconfigurable metasurface unit cell array includes an array of reconfigurable metasurface unit cells to establish a virtual line-of-sight (LoS) path between a transmitter device and receiver device to relay an electromagnetic (EM) wave of a Wi-Fi signal along a non-line-of-sight (NLoS) path between the transmitter device and receiver device. During operation, a reconfigurable metasurface microcontroller unit (MCU) may receive a Wi-Fi sensing request from the transmitter device including a Wi-Fi sensing packet to track changes in Wi-Fi link channels. The reconfigurable metasurface MCU may then execute computer-readable program code of a NLoS sense signal phase profile control system to monitor for angle of arrival and time of flight for an echo signal indicative of an object present within the virtual LoS portion of a Wi-Fi wireless link. In an embodiment, the reconfigurable metasurface MCU may determine a location of the object within the virtual LoS portion based on detected angle of arrival and time of flight in the virtual LoS and create a beamforming pattern at the reconfigurable metasurface to increase signal propagation to a target object being sensed. As such, the reconfigurable metasurface MCU then reports this beamforming direction and location information to the transmitter device to inform the transmitter device of the location of the object and along with its own reception of channel state information (CSI) from the return Wi-Fi sensing data on the Wi-Fi wireless link, the location as well as other characteristics of the target object such as movement and the like, may be detected with Wi-Fi sensing.

The reconfigurable metasurface may include an array of reconfigurable unit cells that have alterable capacitance for changing lobe directionality of reflected signals or for improving received signal sensitivity for reflection by the reconfigurable metasurface in embodiments herein. For example, reconfigurable unit cells In one embodiment, each of the plurality of reconfigurable metasurface unit cells in an array of reconfigurable metasurface unit cells includes a first metasurface reconfigurable split ring, a second metasurface reconfigurable split ring, a third metasurface reconfigurable split ring, a first refractory heater to selectably heat the first metasurface reconfigurable split ring to switch the first metasurface reconfigurable split ring between a conductive state and dielectric state, a second refractory heater to selectably heat the second metasurface reconfigurable split ring to switch the second metasurface reconfigurable split ring between a conductive state and dielectric state, a third refractory heater to selectably heat the third metasurface reconfigurable split ring to switch the third metasurface reconfigurable split ring between a conductive state and dielectric state. The refractory heaters may be activated with a plurality of contact pads to operatively couple the first refractory heater, the second refractory heater, the third refractory heater to a metasurface power management unit (PMU) to provide switchable power to the first refractory heater, the second refractory heater, and the third refractory heater to change the electromagnetic reflective properties of the reconfigurable metasurface unit cell. This reconfigurable metasurface unit cell is just one example embodiment. Other types of reconfigurable metasurface unit cells may be used as well. For example, reconfigurable capacitance of achieved with construction of reconfigurable metasurface unit cells with arrangement of varactor diodes, capacitor banks, integrated switched capacitors, monolithic phase delay elements, monolithic phase shifter, or other systems in embodiments herein.

In an embodiment, the reconfigurable metasurface MCU may execute computer-readable program code of a NLoS sense signal phase backscatter system to create an encoded signal modulated with beamforming direction and location information of a target object relayed within a backscattered signal sent back to the transmitter device. This encoded beamforming direction and location information of a target object may also modulated onto a return signal to report the detected channel characteristics, such as CSI data, on the return Wi-Fi wireless link to the transmitter device. In another embodiment, the reconfigurable metasurface MCU may establish a side band communication with the transmitter device via a reconfigurable metasurface antenna to report the detected beamforming direction and location information of a target object to the transmitter device.

Thus, the presently-described reconfigurable metasurface unit cell array of embodiments herein is real-time configurable that can optimize signal direction and phase continuously, responding to a dynamic wireless environment such as objects detected within the virtual LoS created via the EM wave of a Wi-Fi wireless link being bounced off of the reconfigurable metasurface unit cell array to, for example, a receiver with a sensed object in between. The reconfigurable metasurface unit cell array may enable non-LoS Wi-Fi sensing by establishing virtual LoS links between a plurality of transmitter devices and a plurality of receiver devices via reflection of the reconfigurable metasurface unit cell array. Additionally, the channel state information (CSI) or channel impulse response (CIR) data used to detect changes in the Wi-Fi communication wireless link channel may inform the transmitter or receiver devices conducting Wi-Fi sensing within the environment of the presence of target objects within the environment as well as movement of these objects into and out of the virtual LoS path.

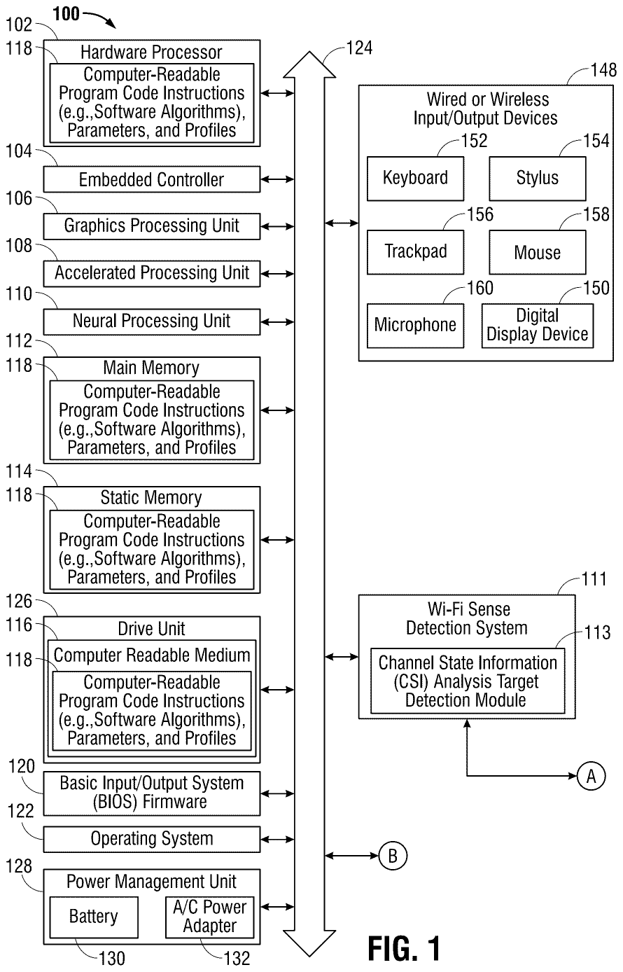

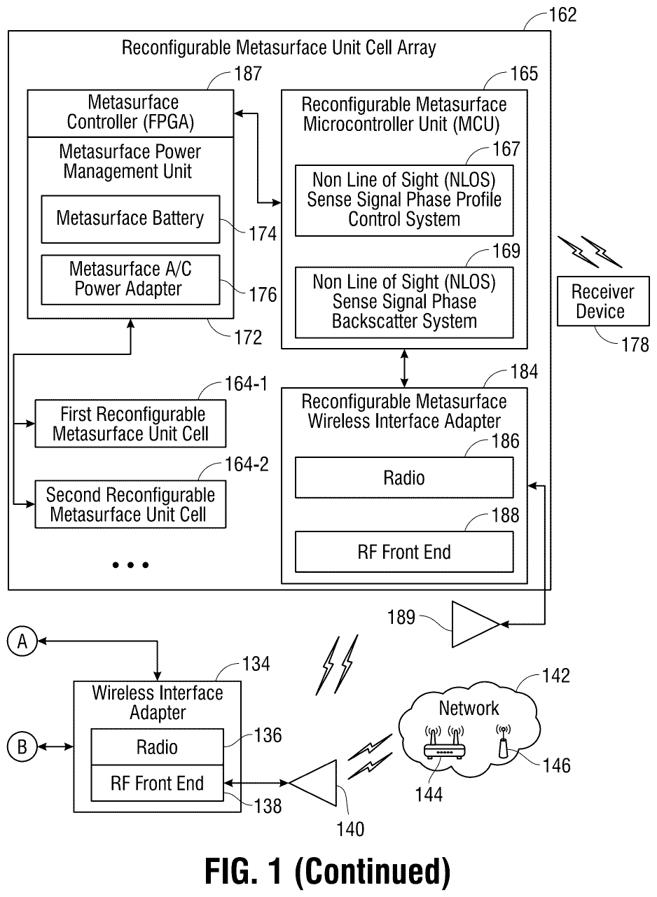

Turning now to the figures, FIG. 1 illustrates an information handling system 100 similar to the information handling systems according to several aspects of the present disclosure that may operate as a source or target radiofrequency device for use with the reconfigurable metasurfaces of the embodiments of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, the wireless interface device 134 with its radio 136, RF front end 138 and antenna 140 is used to communicate with a WWAN or and WLAN which may each include an AP 144 or base station 146 used to operatively couple the information handling system 100 to a network 142 via the wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. It is appreciated that the information handling system 100 may wirelessly communicate with a target receiver device 178 via the reconfigurable metasurface unit cell array 162. The receiver device 178 may be any other device and may include the AP 144, the base station 146, or any other computing device described herein. Additionally, the information handling system 100 and receiver device 178 may be capable of transmitting wireless data using, for example, EM waves that include 5G mm wave lengths such as those included within the 20-50 GHz range or WiFi wavelengths such as 2.4 GHz, 5 GHz, 6 GHz or others to be used with later versions of WiFi. Thus, in an embodiment, the reconfigurable metasurface unit cell array 162 is capable of relaying these types of mm waves.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP 2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may operatively communicate with a receiver device 178 (e.g., another information handling system, an AP 144, a base station 146, etc.) via an intermediary-placed reconfigurable metasurface unit cell array 162. This reconfigurable metasurface unit cell array 162 may be configured to relay or otherwise reflect wireless EM waves transmitted from, for example, the information handling system 100 or other transmitting device and may extend the wireless range or improve signal of the information handling system 100 other transmitting device in communications with a target wireless device such as the receiving device 178. Again, these EM waves may include any type of EM wave including low-band, mid-band, or high-band millimeter-wave EM waves. These may include 600-900 MHz, 1.7-6 GHz, and 24-47 GHz, among other frequencies. Further, these EM waves of a Wi-Fi wireless link may be used to extend range of conducting Wi-Fi sensing into a non-line-of-sight (NLoS) region from a transmitter device such as information handling system 100.

It is appreciated that the reconfigurable metasurface unit cell array 162 may include any type of metasurface technology that may be used to receive and reflect transmitted EM waves from a transmitter device to a receiver device. For example, as described herein, the reconfigurable metasurface unit cell array 162 may include any type of capacitive reconfigurable metasurface unit cell that incorporates varactor diodes (e.g., commercial-off-the-shelf (COTS) varactor diodes), capacitor banks (e.g., COTS capacitor banks), integrated switch capacitors, monolithic phase delay elements, and/or monolithic phase shifters. In a specific embodiment, the reconfigurable metasurface unit cell array 162 may include an array of rings of phase change material or non-volatile phase change material that, when heated, may be transformed between two distinct states: an amorphous state and a crystalline state. For ease in explanation, the reconfigurable metasurface unit cell array 162 described herein may include this array of rings of phase change material or non-volatile phase change material that, when heated, may be transformed between two distinct states: an amorphous state and a crystalline state.

The reconfigurable metasurface unit cell array 162 may include a plurality of reconfigurable metasurface unit cells, such as the first reconfigurable metasurface unit cell 164-1 and a second reconfigurable metasurface unit cell 164-2 is shown in FIG. 1. It is appreciated that the reconfigurable metasurface unit cell array 162 may contain any number of reconfigurable metasurface unit cells 164-1, 164-2. In one example embodiment, the reconfigurable metasurface unit cell array 162 may contain two-hundred and fifty-six reconfigurable metasurface unit cells 164-1, 164-2 arranged in a sixteen-by-sixteen array. It is appreciated that the reconfigurable metasurface unit cell array 162 may include any plurality of reconfigurable metasurface unit cells 164-1, 164-2 in any arrangement of those unit cells 164-1, 164-2. As described herein, the reconfigurable metasurface unit cells 164-1, 164-2 within the reconfigurable metasurface unit cell array 162 may be used to, in real-time, to reconfigure its reflective properties to control the refection and steering of incoming EM waves from a transmitting source (e.g., the wireless antenna 140 of the wireless interface adapter 134 of the information handling system 100, an AP 144, or other transmitter device) to a receiver device 178 according to embodiments herein.

As described herein, the reconfigurable metasurface unit cell array 162 may be operatively coupled to a metasurface PMU 172 and the reflective properties may be controlled via a metasurface controller 187 that may be a field programmable gate array (FPGA) circuit microchip or other hardware controller at the reconfigurable metasurface unit cell array 162. Like the PMU 128 of the information handling system 100, the metasurface PMU 172 may include control from the metasurface controller 187 to provide power to each of the reconfigurable metasurface unit cells 164-1, 164-2. In an embodiment, the power needed to operate the reconfigurable metasurface unit cell array 162 may be low such that the metasurface battery 174 may be sufficient to change the properties of the reconfigurable metasurface unit cells 164-1, 164-2 in order to engage in the beamforming processes described herein.

During operation, a reconfigurable metasurface MCU 165 of the reconfigurable metasurface unit cell array 162 may receive Wi-Fi sensing input in a Wi-Fi communication link from the information handling system 100 executing computer-readable program code of a Wi-Fi sense detection system 111. The Wi-Fi sense detection system 111 may, among other tasks, relay packet signals to the reconfigurable metasurface unit cell array 162 on a Wi-Fi communication link indicating that a context aware Wi-Fi sensing session is active. This Wi-Fi sensing session may, when activated, monitor for certain channel state data on channels of the Wi-Fi communication link established with a receiver device 178 also enabled for Wi-Fi sensing via reflection of the Wi-Fi communication link with the reconfigurable metasurface unit cell array 162. The Wi-Fi sensing may indicate that an object such as a human is within, is moving within, and/or is passing through the virtual LoS created between the information handling system 100 and the receiver device 178 by way of the reconfigurable metasurface unit cell array 162. As described herein, this may come in the form of propagation loss data or phase shifting on the communication wireless link channel or channels that comprises channel state information (CSI) for channel impulse response (CIR) data. This CSI and/or CIR data may inform the devices within the environment including the transmitter device and the receiver device 178 of those objects in the environment that are within, passing through, and moving with the virtual LoS path of the wireless communication link. The virtual LoS portion of the wireless link may be formed via the reconfigurable metasurface unit cell array 162 reflecting the wireless link to the receiver device and a target object within a NLoS region from the transmitter device such as information handling system 100. In an embodiment, the CSI data, including the CIR data from a Wi-Fi sensing packet sent on the Wi-Fi communication link, may be in reference to either bistatic or monostatic detection of an object within the environment that the reconfigurable metasurface unit cell array 162 is placed. Bi-static involves a separate transmitter device, such as information handling system 100, and a receiver device 178 on the wireless link. Monostatic involves transmission and reception on the same transmitter device and often involves closer range object detection to the transmitter device.

The reconfigurable metasurface MCU 165 of the reconfigurable metasurface unit cell array 162 may, therefore, monitor for changes angle of arrival and time of flight of signals within the virtual LoS portion of the Wi-Fi wireless link including the Wi-Fi sensing packet transmitted on the Wi-Fi wireless link. Signals returned to the reconfigurable metasurface unit cell array 162 from target object and the receiver device 178 are assessed for angle of arrival and time or flight to determine direction and location of a target object in the virtual LoS portion. The reconfigurable metasurface MCU 165 may transmit this beamforming direction and location information of a target object to, for example, the Wi-Fi sense detection system 111 to process along with CSI data for the channel of the Wi-Fi wireless link via Wi-Fi sensing. For example, the Wi-Fi sense detection system 111 may cause that computer-readable program code instructions of a channel state information analysis target detection module 113 to be executed to process any CSI propagation data sent as well as beamforming direction and location information of a target object sent by the reconfigurable metasurface MCU 165.

In an embodiment, the reconfigurable metasurface MCU 165 may execute computer-readable program code instructions of a non-line-of-sight (NLoS) sense signal phase profile control system 167 to monitor for this angle of arrival and time of flight of an echo signal of an object present within the virtual line-of-sight (LoS) after reflection of a Wi-Fi wireless link EM wave signal from the reconfigurable metasurface unit cell array 162. When detected, this angle of arrival and time of flight data may be used to determine beamforming pattern direction and location of a target object and this information relayed back to the transmitter device to inform the transmitter device (e.g., the information handling system 100 or receiver device 178) about objects that have entered, are present, and/or are moving through the virtual LoS channel on the other side of the reconfigurable metasurface unit cell array 162. This beamforming of the Wi-Fi wireless link by the reconfigurable metasurface unit cell array 162 mitigates loss in the Wi-Fi wireless link reflected signal returning from a remote receiver device in an embodiment and thus extends a virtual LoS Wi-Fi sense signal for the Wi-Fi sense detection system 111 at the transmitter information handling system device.

In an embodiment, the reconfigurable metasurface MCU 165 may use backscatter signal in order to transmit this beamforming direction and location data of a target object. Where, for example, the reconfigurable metasurface MCU 165 determines an angle of arrival and time of flight data for a target object in the virtual LoS extension beyond the reconfigurable metasurface unit cell array 162, the reconfigurable metasurface MCU 165 may also execute computer-readable program code instructions to transmit determined beamforming direction and location information of the sensed object back to the transmitter information handling system 100 with a non-LoS sense signal phase backscatter system 169. The non-LoS sense signal phase backscatter system 169 encodes a signal within a relayed backscatter signal that is reflected or sent back to the transmitter device information handling system 100 to report the detected beamforming directionality and location information for the target object to the transmitter device information handling system. This non-LoS sense signal phase backscatter system 169 therefore does not require significant additional power to transmit a separate signal, but uses already backscattered signals for encoding with a backscatter signal the beamforming directionality and location information for the target object in embodiments herein. The encoding used may be any type of modulation such as binary phase shift keying (BPSK) or amplitude shift keying by toggling the reconfigurable metasurface unit cell or cells between different states to modulate the backscattered signals to the transmitter information handling system 100.

In another embodiment, the reconfigurable metasurface MCU 165 may use a side band communication process in order to transmit this beamforming directionality and location information for the target object to the transmitter device. Thus, in an embodiment, the reconfigurable metasurface MCU 165 may be operatively coupled to a reconfigurable metasurface wireless interface adapter 184 that includes a radio 186, an RF front end 188, and a reconfigurable metasurface antenna 189 that supports the creation and use of this side band channel to communicate with the transmitter device information handling system.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

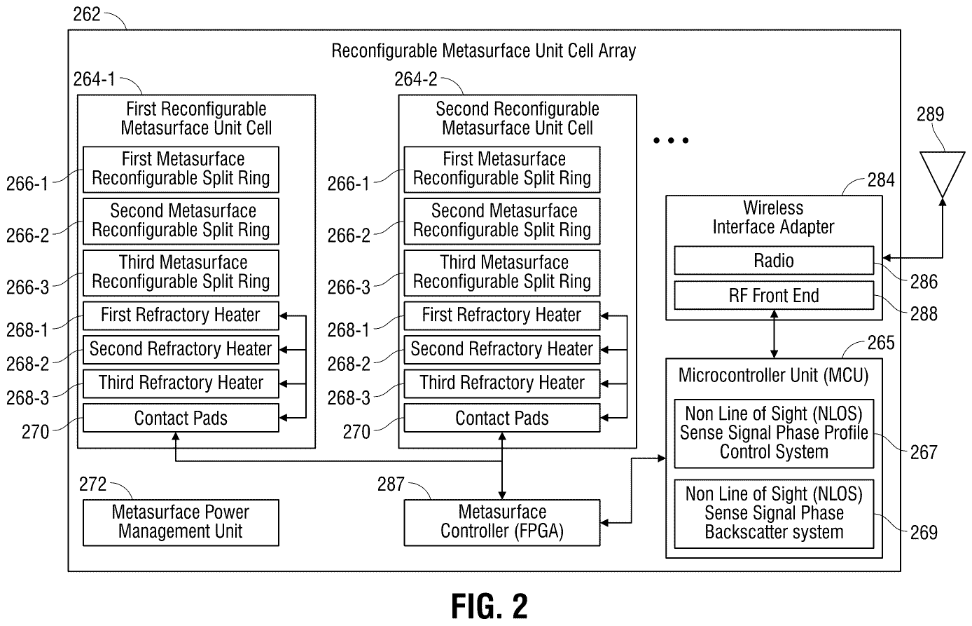

FIG. 2 is a block diagram illustrating a reconfigurable metasurface unit cell array 262 operating within a Wi-Fi sensing system according to an embodiment of the present disclosure. As described herein, the reconfigurable metasurface unit cell array 262 may incorporate any type of reconfigurable surface that may be used to receive and reflect transmitted EM waves from a transmitter device to a receiver device for purposes of extending a virtual LoS path for extended Wi-Fi sensing and directionality of a target object. For example, as described herein, the reconfigurable metasurface unit cell array 262 may include any type of capacitive unit cell that incorporates varactor diodes (e.g., commercial-off-the-shelf (COTS) varactor diodes), capacitor banks (e.g., COTS capacitor banks, integrated switch capacitors, monolithic phase delay elements, and/or monolithic phase shifters. In the specific embodiment shown and described in FIG. 2, the reconfigurable metasurface unit cell array 262 may include an array of rings of phase change material or non-volatile phase change material that, when heated, may be transformed between two distinct states: an amorphous state and a crystalline state.

Thus, in an embodiment, each of the reconfigurable metasurface unit cells 264-1, 264-2 may include a first metasurface reconfigurable split ring 266-1, a second metasurface reconfigurable split ring 266-2, and a third metasurface reconfigurable split ring 266-3. In an embodiment, each of the metasurface reconfigurable split rings 266-1, 266-2, 266-3 may be made of a non-volatile phase change material and a conductive bridge to complete each split ring. This phase change material may include, for example, germanium telluride (GeTe), antimony telluride (SbTe), or chalcogenide (GeSbTe) among other similar non-volatile phase change materials. The non-volatile phase change material of the metasurface reconfigurable split rings 266-1, 266-2, 266-3 may have two distinct states: an amorphous state and a crystalline state. In an embodiment, when the non-volatile phase change materials are in an amorphous state, the metasurface reconfigurable split rings 266-1, 266-2, 266-3 have a high resistance for a dielectric state. In an embodiment, when the non-volatile phase change materials are in a crystalline state, the metasurface reconfigurable split rings 266-1, 266-2, 266-3 may have a low resistance for a conductive state. In an embodiment, switching between the amorphous state and the crystalline state may be achieved via application of thermal energy from one of a plurality of first refractory heater 268-1, second refractory heater 268-2, and third refractory heater 268-3 corresponding to each metasurface reconfigurable split ring 266-1, 266-2, 266-3 described herein. In an embodiment, the non-volatile phase change materials may hold a state as long as it is not actuated with another heat pulse to transition to the alternate state as either the amorphous state or the crystalline state.

In an embodiment, each of the metasurface reconfigurable split rings 266-1, 266-2, 266-3 may be selectively switched from a conductive state to an dielectric state in order to modify constructive and/or destructive interference of the metasurface reconfigurable split rings 266-1, 266-2, 266-3 with the center conductive node and outer conductive ring on the incoming EM wave thereby reflectively steering the EM wave in a specific direction such as in the direction of the receiver device 278. Via the use of the constructive and/or destructive interference, any number of EM wave beam directions may be created that may be used to increase the feed distance of the EM wave beams in order to expand radiofrequency signal range or focus the directionality of the EM wave beams for the radiofrequency signals in an radiofrequency environment. In an embodiment, the directionality and feed distance of the EM wave beams may be changed (e.g., the array of reconfigurable metasurface unit cells 264-1, 264-2 may be reconfigured) within sub-milliseconds such that data may be transmitted to various different locations within an area.

As described in embodiments herein, each of the reconfigurable metasurface unit cells 264-1, 264-2 may include a first refractory heater 268-1, a second refractory heater 268-2, and a third refractory heater 268-3 to, each, selectively apply heat pulses to the first metasurface reconfigurable split ring 266-1, the second metasurface reconfigurable split ring 266-2, and the third metasurface reconfigurable split ring 266-3, respectively. In an embodiment, each of the refractory heaters 268-1, 268-2, 268-3 may be made of tungsten (W). In an embodiment, the first metasurface reconfigurable split ring 266-1, the second metasurface reconfigurable split ring 266-2, and the third metasurface reconfigurable split ring 266-3 are formed into a first layer with the first refractory heater 268-1, the second refractory heater 268-2, and the third refractory heater 268-3 formed into a second layer and electrically insulated. In an embodiment, the first layer is separated from the second layer by a dielectric layer made of, for example, silicon nitride (SiNx) or aluminum nitride (AlN). This dielectric layer may act as an electric insulator that prevents the flow of electric current from the refractory heaters 268-1, 268-2, 268-3 but be thermally conductive.

In an embodiment, each of the refractory heaters 268-1, 268-2, 268-3 are operatively coupled to a contact pad 270. The contact pads 270 may serve as a contact pad through which a metasurface PMU 272, as controlled with metasurface controller 287 may provide power to each of the refractory heaters 268-1, 268-2, 268-3 to generate heat pulses for each of the respective reconfigurable metasurface unit cells 264-1, 264-2. In an embodiment, additional layers may be formed below the refractory heaters 268-1, 268-2, 268-3. In an embodiment, these layers may include an electrical dielectric substrate made of, for example, high-resistivity silicon (HRSi), aluminum oxide (Al2O3), glass, or printed circuit board among others placed below the second layer. These layers may be thermally insulative. In an embodiment, a metallization layer used as a radio frequency (RF) ground may be placed below the electrical dielectric substrate and may be made of copper or other metal. Another dielectric layer made of, for example, silicon dioxide (SiO2) may be placed below the metallization layer and above the contact pads 270. Thus, in an embodiment, a number of vias are formed through the electrical dielectric substrate, the metallization layer with isolation, and the dielectric layer below the refractory heaters 268-1, 268-2, 268-3 so that the contact pads 270 may be operatively coupled to the refractory heaters 268-1, 268-2, 268-3 via one or more metal interconnects.

In an embodiment, each of the reconfigurable metasurface unit cells 264-1, 264-2 may include other structures used to redirect transmitted EM waves and beam steer those EM waves in a desired direction. In an example embodiment, the reconfigurable metasurface unit cells 264-1, 264-2 may each include a non-reconfigurable metal fixed outer ring formed around the metasurface reconfigurable split rings 266-1, 266-2, 266-3 described herein. The non-reconfigurable metal fixed outer ring may form a passive conductive ring such that it does not require power from the metasurface PMU 272 to maintain its characteristics to contribute to the redirection of the transmitted EM waves and beam steering of those EM waves in a desired direction. In an embodiment, along with the non-reconfigurable metal fixed outer ring, each of the non-reconfigurable metal fixed split ring unit cells 264-1, 264-2 may also include a non-reconfigurable metal fixed center node formed within each of the first metasurface reconfigurable split ring 266-1 of each reconfigurable metasurface unit cell 264-1, 264-2 to also act as a passive conductive dot or pad such that it does not require power from the metasurface PMU 272 to maintain its characteristics to contribute to the redirection of the transmitted EM waves and beam steering of those EM waves in a desired direction.

As described herein, the reconfigurable metasurface unit cell array 262 may be operatively coupled to a metasurface PMU 272 and controlled via a metasurface controller 287 that may be a field programmable gate array (FPGA) circuit microchip or other hardware controller at the reconfigurable metasurface unit cell array 262. Like the PMU 228 of the information handling system 200, the metasurface PMU 272 may include control from the metasurface controller 287 to provide power to each of the refractory heaters 268-1, 268-2, 268-3 for triggered heat pulses via one or a combination of both a metasurface battery 274 and metasurface A/C power adapter 276. In an embodiment, the power needed to operate the reconfigurable metasurface unit cell array 262 may be low such that the metasurface battery 274 may be sufficient to pulse heat to the individual refractory heaters 268-1, 268-2, 268-3 in order to switch the metasurface reconfigurable split rings 266-1, 266-2, 266-3 from an amorphous state to a crystalline state or vice versa.

By switching each of the metasurface reconfigurable split rings 266-1, 266-2, 266-3 between the amorphous state and the crystalline state, the reconfigurable metasurface unit cell array 262 may be configured to redirect transmitted EM waves and beam steer those EM waves in a desired direction and may be controlled via the metasurface controller 287. Additionally, because the heating of the phase change material of the metasurface reconfigurable split rings 266-1, 266-2, 266-3 can be achieved by applying thermal energy such as a pulse with a certain amplitude and width (on the order of nanoseconds) through the electrically insulated high-speed, refractory heaters 268-1, 268-2, 268-3, the constant application of power is not needed thereby reducing the need for a dedicated power source. Indeed, in some embodiments, these phase change materials of the metasurface reconfigurable split rings 266-1, 266-2, 266-3 hold their states as long as it is not actuated with another heat pulse to change to the other crystalline or amorphous phase.

Again, in an embodiment, the reconfigurable metasurface MCU 265 may use backscatter principles in order to transmit this propagation loss data. Where, for example, the reconfigurable metasurface MCU 265 discovers that an EM wave signal exhibits propagation loss, the reconfigurable metasurface MCU 265 may also execute computer-readable program code instructions of a non-LoS sense signal phase backscatter system 269 to create an encoded signal within a relayed signal sent back to the transmitter device to report the detected channel characteristics to the transmitter device.

In another embodiment, the reconfigurable metasurface MCU 265 may use a side band communication process in order to transmit this propagation loss data to the transmitter device. Thus, in an embodiment, the reconfigurable metasurface MCU 265 may be operatively coupled to a reconfigurable metasurface wireless interface adapter 284 that includes a radio 286, an RF front end 288, and a reconfigurable metasurface antenna 289 that supports the creation and use of this side band channel to communicate with the transmitter device.

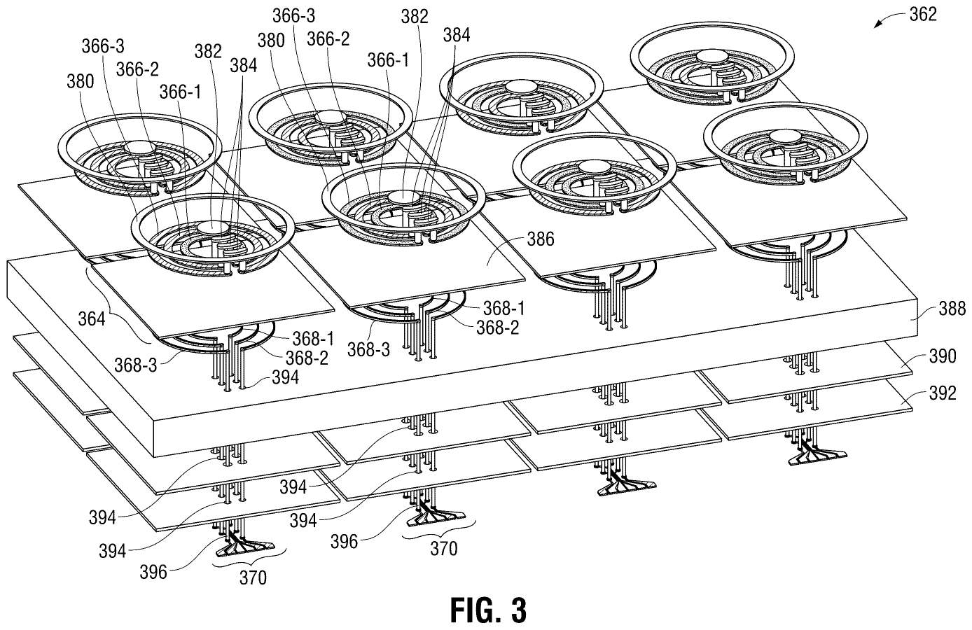

FIG. 3 is a graphic diagram showing an exploded perspective view of the reconfigurable metasurface unit cell array according to an embodiment of the present disclosure. In this example, FIG. 3 is a perspective view exploded graphic diagram illustrating a plurality of unit cells 364 of a reconfigurable metasurface unit cell array 362 according to one embodiment of the present disclosure. The reconfigurable metasurface unit cells 364 of FIG. 3 are one type of unit cell with reconfigurable capacitance for a reconfigurable metasurface unit cell array that may be used with embodiments herein for extension of a virtual LoS wireless link signal for effective range and directionality extension of Wi-Fi sensing in embodiments herein. FIG. 3 illustrates one embodiment used to conduct reconfigurability for switching directionality of a reflected EM waves of a Wi-Fi link signal to an extended virtual LoS portion of the wireless link as well as for backscatter signal direction back to a transmitter device information handling system in various embodiments herein.

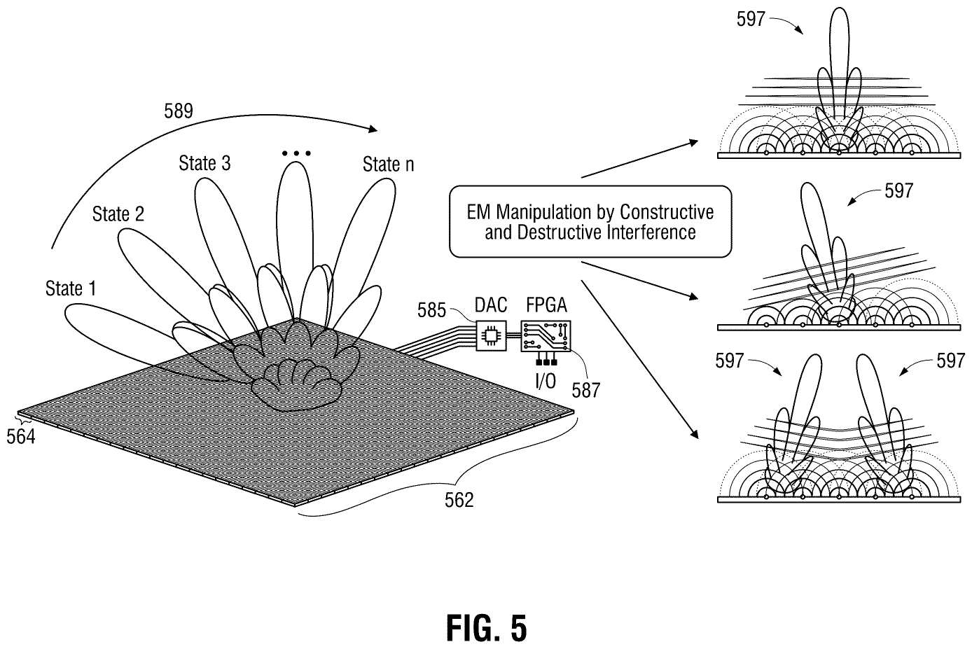

As shown in FIG. 3, each reconfigurable metasurface unit cell 364 may include a staking of various elements similar to those presented in FIG. 2 for example. It is appreciated that each of the reconfigurable metasurface unit cells 364 of the reconfigurable metasurface unit cell array 362 may comprise their own various layers or may, in an embodiment, share the same layer or layers within the array. Again, the reconfigurable metasurface unit cell 564 shown in FIG. 5 may one of a plurality of unit cells 364 that form the reconfigurable metasurface unit cell array 362 and may include any number of unit cells 364 arranged in any manner on a two-dimensional plane. In an embodiment, the reconfigurable metasurface unit cell array 362 may be an array of sixteen unit cells 364 by sixteen unit cells 364. It is also appreciated that although FIG. 3 shows the various elements of the plurality of reconfigurable metasurface unit cells 364, for purposes of discussion the bottom-left two reconfigurable metasurface unit cells 364 are discussed, however, the other unit cells 364 depicted in FIG. 3 include similar elements and operation as described in FIG. 2.

As shown in FIG. 3, the reconfigurable metasurface unit cells 364 include concentrically formed first metasurface reconfigurable split ring 366-1, second metasurface reconfigurable split ring 366-2, and third metasurface reconfigurable split ring 366-3 on a first layer of the reconfigurable metasurface unit cell 364. Each of these metasurface reconfigurable split rings 366-1, 366-2, 366-3 may include any phase change materials such as GeTe, SbTe, or GeSbTe among other similar non-volatile phase change materials. The metasurface reconfigurable split rings 366-1, 366-2, 366-3 share the same layer as the non-reconfigurable metal fixed ring 380 and non-reconfigurable metal fixed center node 382 and act together to focus (e.g., increase or decrease the feed distance) the directionality (e.g., beam steering) of the EM wave beams reflected off of the reconfigurable metasurface unit cell array 362 as described in embodiments herein. In an embodiment, the non-reconfigurable metal fixed ring 380 and non-reconfigurable metal fixed center node 382 may be made of a metal such as Au, Cu, Al, Ni among other types of conductive metals. It is appreciated that the metasurface reconfigurable rings 366-1, 366-2, 366-3, the non-reconfigurable metal fixed ring 380, and the non-reconfigurable metal fixed center node 382 may be formed onto the same layer and may be referred to herein as a first layer of any given unit cell 364.

In an embodiment, each of the metasurface reconfigurable split rings 366-1, 366-2, 366-3 may include a split or gap along the circumference of the metasurface reconfigurable split rings 366-1, 366-2, 366-3. As shown in FIG. 3, for example, this gap correlates with a gap in each of the respective refractory heaters 368-1, 368-2, 368-3 formed below the first layer so the refractory heaters 368-1, 368-2, 368-3 may operate. In order, however, to complete a conductive ring structure when phase change material is in a conductive state of each of the metasurface reconfigurable split rings 366-1, 366-2, 366-3, this gap in each metasurface reconfigurable split rings 366-1, 366-2, 366-3 may be bridged using a conductive bridge 384. The conductive bridge 384 allows for induced currents in each of the metasurface reconfigurable split rings 366-1, 366-2, 366-3 to create radiated fields that form the reflected wave patterns described in embodiments herein.

Below this first layer comprised of the metasurface reconfigurable split rings 366-1, 366-2, 366-3, the non-reconfigurable metal fixed ring 380, and the non-reconfigurable metal fixed center node 382, the reconfigurable metasurface unit cell 364 includes a first dielectric layer 386. This first dielectric layer 386 may be made of SiNx of AlN. In an embodiment, this first dielectric layer 386 may include any insulating substance that does not conduct electricity but may also support electrostatic fields created during operation of the reconfigurable metasurface unit cell 364. This first dielectric layer 386 may still be thermally conductive however in embodiments herein. In an embodiment, the first dielectric layer 386 may be shared among all unit cells 364 within the reconfigurable metasurface unit cell array 362. In another embodiment shown in FIG. 3, each reconfigurable metasurface unit cell 364 has its own dedicated first dielectric layer 386.

Below the first dielectric layer 386, a second layer may be formed that comprise the first refractory heater 368-1, the second refractory heater 368-2, and the third refractory heater 368-3. The refractory heaters 368-1, 368-2, 368-3 may each, individually and selectively, heat their respective metasurface reconfigurable split ring 366-1, 366-2, 366-3. Thus, when a power source is applied to the first refractory heater 368-1, the first refractory heater 368-1 heats the first metasurface reconfigurable split ring 366-1. Additionally, when the power source is applied to the second refractory heater 368-2, the second refractory heater 368-2 heats the second metasurface reconfigurable split ring 366-2. Further, when a power source is applied to the third refractory heater 368-3, the third refractory heater 368-3 heats the third metasurface reconfigurable split ring 366-3. Thus, the states of each of the metasurface reconfigurable split rings 366-1, 366-2, 366-3 may be individual controlled via heating of the individual refractory heaters 368-1, 368-2, 368-3 such that the states of the metasurface reconfigurable split rings 366-1, 366-2, 366-3 may be switched from their amorphous states to their crystalline states or vice versa. It is appreciated that the number of refractory heaters 368-1, 368-2, 368-3 shown in FIG. 3 is merely an example number of refractory heaters 368-1, 368-2, 368-3 and where the number of metasurface reconfigurable rings 366-1, 366-2, 366-3 increases beyond the three shown, a commensurate number of refractory heaters 368-1, 368-2, 368-3 may also be added to accommodate for the extra number of metasurface reconfigurable rings 366-1, 366-2, 366-3. Additionally, where the number of refractory heaters 368-1, 368-2, 368-3 increases beyond the three shown in FIG. 3, a commensurate number of contact pads 370, metal interconnect layers 396, and vias 394 are also increased to accommodate for the application of the power pulses to the additional refractory heaters 368-1, 368-2, 368-3.

It is appreciated that the voltage and current applied to each of the refractory heaters 368-1, 368-2, 368-3 controls the states of the metasurface reconfigurable split rings 366-1, 366-2, 366-3. For example, where the voltage applied to any of the refractory heaters 368-1, 368-2, 368-3 is high (e.g., 15-20 V) for a short period of time (e.g., up to 0.5 microseconds (μs)) with a peak current of 300 to 310 mA, the metasurface reconfigurable split rings 366-1, 366-2, 366-3 are transitioned to an amorphous state. This application of this voltage at this current creates a peak temperature at a metasurface reconfigurable split ring 366-1, 366-2, 366-3 of 700 to 800° C. in order to transition from the crystalline state to this amorphous state in this example. However, where the voltage applied to any of the refractory heaters 368-1, 368-2, 368-3 is relatively lower (e.g., 9-10 V) for a relatively longer period of time (e.g., 2 μs) with a peak current of 210 to 220 mA the metasurface reconfigurable split rings 366-1, 366-2, 366-3 are transitioned to a crystalline state. This application of this voltage at this current creates a peak temperature at a metasurface reconfigurable split ring 366-1, 366-2, 366-3 of 400 to 410° C. in order to transition from the amorphous state to this crystalline state in this example. It is appreciated that in order to place the non-volatile phase change material of the metasurface reconfigurable split rings 366-1, 366-2, 366-3 into an amorphous state or a crystalline state depends on the type of non-volatile phase change material used. Thus, the electrical pulse from the metasurface PMU (e.g., FIGS. 1, 172) at an applied voltage and current to each of the refractory heaters 368-1, 368-2, 368-3 to change the state of the non-volatile phase change material of each metasurface reconfigurable split ring 366-1, 366-2, 366-3 may depend on the type of non-volatile phase change material used and the present specification contemplates that other non-volatile phase change materials may be used necessitating changes in these applied voltages and currents.

Other layers and substrates may also be included in the stack within the reconfigurable metasurface unit cell 364. In an example embodiment, the reconfigurable metasurface unit cell 364 may further include an electrical dielectric substrate 388 placed below the second layer that comprises the refractory heaters 368-1, 368-2, 368-3. This electrical dielectric substrate 388 may be made of a HRSI, Al₂O₃, glass, or PCB among other dielectric materials. In an embodiment, the first dielectric layer 386 and electrical dielectric substrate 388 may electrically isolate the refractory heaters 368-1, 368-2, 368-3 from the remaining portions of the reconfigurable metasurface unit cell 364. Again, it is appreciated that each of the reconfigurable metasurface unit cells 364 of the reconfigurable metasurface unit cell array 362 may share the same layer of electrical dielectric substrate 388 as shown in FIG. 3. However, the present specification also contemplates that each reconfigurable metasurface unit cell 364 may have their own layer of electrical dielectric substrate 388 disconnected from the electrical dielectric substrates 388 of the other unit cells 364.

In an embodiment, a metallization layer 390 may be formed below the electrical dielectric substrate 388. This metallization layer 390 may be made of Au, Cu, Al, or Ni among other types of metals. In an embodiment, this metallization layer 390 may serve as an RF grounding source for the reconfigurable metasurface unit cell 364. Again, it is appreciated that each of the reconfigurable metasurface unit cells 364 of the reconfigurable metasurface unit cell array 362 may share the same layer of metallization layer 390. However, the present specification also contemplates that each reconfigurable metasurface unit cell 364 may have their own layer of metallization layer 390 disconnected from the metallization layer 390 of the other unit cells 364 as shown in FIG. 3.

In an embodiment, a second dielectric layer 392 may be placed below the metallization layer 390. This second dielectric layer 392 may be made of silicon dioxide (SiO₂). Similar to the first dielectric layer 386, the second dielectric layer 392 may also support electrostatic fields created during the operation of the reconfigurable metasurface unit cell 364. Again, it is appreciated that each of the reconfigurable metasurface unit cells 364 of the reconfigurable metasurface unit cell array 362 may share the same layer of second dielectric layer 392. However, the present specification also contemplates that each unit cell 364 may have their own layer of second dielectric layer 392 disconnected from the second dielectric layers 392 of the other unit cells 364 as shown in FIG. 3.

Below the second dielectric layer 392, the contact pads 370 used to electrically couple the refractory heaters 368-1, 368-2, 368-3 to a metasurface PMU (e.g., FIG. 1 172) are shown. The contact pads 370 may be made of any conductive metal such as Au, Cu, Al, or Ni among other types of metals. The contact pads 370 may receive those electrical pulses from the metasurface PMU in order to heat, individually, each of the refractory heaters 368-1, 368-2, 368-3. In order to operatively couple each of the refractory heaters 368-1, 368-2, 368-3 to a respective contact pad 370, a plurality of metal interconnect layers 396 are formed. In the example embodiment shown in FIG. 3, the metal interconnect layers 396 couple a contact pad to each terminal end of each of the refractory heaters 368-1, 368-2, 368-3. In order to do so, one or more vias 394 are formed through, at least, the second dielectric layer 392, the metallization layer 390, and the electrical dielectric substrate 388 so that the metal interconnect layers 396 may pass from each of the respective contact pads 370 to their respective refractory heaters 368-1, 368-2, 368-3.

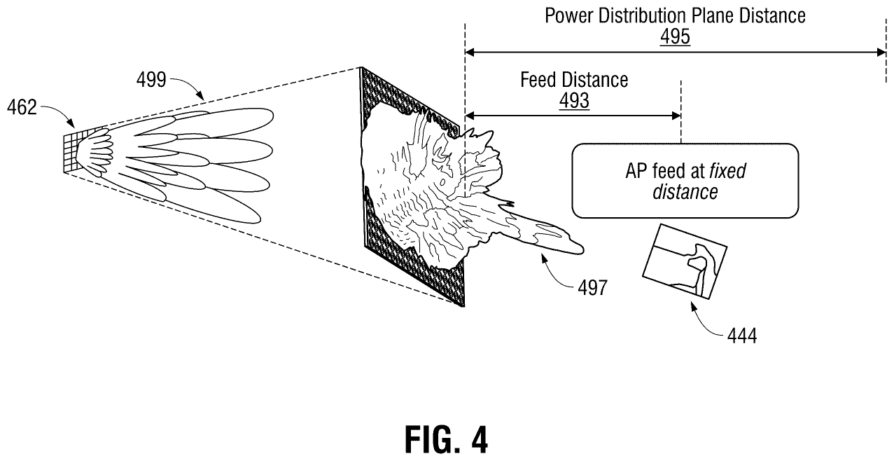

FIG. 4 is a graphic diagram of a reconfigurable metasurface unit cell array and its electromagnetic wave reflection properties according to an embodiment of the present disclosure. FIG. 4 graphic diagram of a reconfigurable metasurface unit cell array and its electromagnetic wave reflection properties according to an embodiment of the present disclosure. It is appreciated that this reconfigurable metasurface unit cell array 462 may be located on any surface within a radiofrequency environment such as an office, home, or other space such as a wall or placed on an A-cover or top cover of the laptop-type information handling system in various embodiments herein. In an embodiment, the reconfigurable metasurface unit cell array 462 may be a Wi-Fi reconfigurable metasurface unit cell array 462 that is used to reflect incoming EM waves off of a surface within an EM wave environment for Wi-Fi communication wireless links, thereby treating those surfaces as a relay location of EM waves within any radiofrequency environment such as an office environment.

FIG. 4 also shows that the resulting EM wave reflection pattern 499 is shown in larger detail. This EM wave reflection pattern 499 include a focused beam that has a specific directionality. As described one embodiment herein, the configuration of the metasurface reconfigurable rings via actuation of the refractory heaters causes each individual metasurface reconfigurable ring to change from an amorphous state to a crystalline state or vice versa to adjust directionality of each reconfigurable metasurface unit cell within the reconfigurable metasurface unit cell array 462. The configuration of each of these metasurface reconfigurable rings within each of the reconfigurable metasurface unit cells of the reconfigurable metasurface unit cell array 462 causes each unit cell to engage in destructive or constructive interference, between concentric rings as well as between the plurality of reconfigurable metasurface unit cells, in order to create controllable focused beams 497 within the EM wave reflection pattern 499.

In other embodiments, controllable capacitance of any type of reconfigurable metasurface unit cells, such as with any type of capacitively reconfigurable metasurface unit cell that incorporates varactor diodes, capacitor banks, integrated switch capacitors, monolithic phase delay elements, monolithic phase shifters or similar systems may generate constructive or destructive interference by the reconfigurable metasurface unit cell array 462. Any of these reconfigurable metasurface unit cells of the reconfigurable metasurface unit cell array 462 in embodiments herein causes each unit cell to engage in destructive or constructive interference between the plurality of reconfigurable metasurface unit cells to create controllable focused beams 497 within the EM wave reflection pattern 499. As shown in FIG. 4, this focused beam 497 is directed towards receiver device 444 at a known or detected location or may, in embodiments herein be directed towards an object for sensing in a virtual LoS portion of a Wi-Fi wireless link from the reconfigurable metasurface unit cell array 462. The feed distance 493 of this focused beam 497 may be sufficient to extend the reflected EM wave to the receiver device 444 so that radiofrequency signal data, such as for a Wi-Fi wireless link, may be efficiently transferred from a transmitting device (not shown), reflected off of the reconfigurable metasurface unit cell array 462, and received by the receiver device 444 according to embodiments herein. This focused beam 497 may also extend to better sense an object within the virtual LoS extended path from the reconfigurable metasurface unit cell array 462 to and towards a sensed object in embodiments herein.

FIG. 4 also shows a power distribution plane distance 495. This power distribution plane distance 495 may describe the distance from the reconfigurable metasurface unit cell array 462 where the reflected EM waves reach a relatively uniform power distribution across its plane. This means that the wavefront is considered to be a far field region several wavelengths away from the reconfigurable metasurface unit cell array 462.

FIG. 5 is a graphic diagram of various emission states of a reconfigurable metasurface unit cell array 5562 operated by a digital-to-analog converter (DAC) 593 and a field programmable gate array (FPGA) 591 operating as a metasurface controller according to an embodiment of the present disclosure. The DAC 593 and a metasurface controller such as an FPGA 591 may be formed on a printed circuit board with a power source or PMU and operatively coupled to the reconfigurable metasurface unit cell array 562. This DAC 593, metasurface controller such as an FPGA 591, and power source may be operatively coupled to contact pads of the reconfigurable metasurface unit cells of the reconfigurable metasurface unit cell array 562 in embodiments herein. FIG. 5 shows an example of the reconfigurable metasurface unit cell array 562 comprising an array of sixteen-by-sixteen reconfigurable metasurface unit cells that cooperate to direct and beamform a reflected EM wave.

As described herein, the each of the reconfigurable metasurface unit cells 564 may be controlled via use of a metasurface controller such as FPGA 587 that controls power provided from a power source, such as PMU with battery or A/C power source, to each of the refractory heaters in order to change the metasurface reconfigurable split rings from amorphous state to a crystalline state or vias versa. In one embodiment shown in FIG. 5, the metasurface PMU may provide power to the DAC 593 and an FPGA 587 that selectively applies the electrical pulses of power to each individual metasurface reconfigurable split ring of each unit cell within the reconfigurable metasurface unit cell array 562. In other embodiments, the FPGA 587 may apply control signals to adjust capacitance of any type of reconfigurable metasurface unit cells of the reconfigurable metasurface unit cell array 562 to cause each unit cell to engage in destructive or constructive interference in order to control the focused beam 597 within the EM wave reflection pattern in a plurality of directions or states. As described, controllable capacitive reconfigurable metasurface unit cells that incorporate varactor diodes, capacitor banks, integrated switch capacitors, monolithic phase delay elements, and/or monolithic phase shifters may be used to control the focused beam 597 within the EM wave reflection pattern in a plurality of directions or states in various embodiments herein.

The FPGA 587 may be any integrated circuit that contains the digital logic to actuate each refractory heater such that the state of each metasurface reconfigurable split ring can be changed between an amorphous to a crystalline state or vice versa or to actuate other controllable capacitance structure of reconfigurable metasurface unit cells in order to create a transmission state and direction of the reflected EM waves and focused beams 597 off of the surface of the reconfigurable metasurface unit cell array 562. In an embodiment, a look-up table may be made accessible by the FPGA 587 the describes how the FPGA 587 is to activate each of the refractory heaters or other controllable capacitance structure of reconfigurable metasurface unit cells in order to create destructive or constructive interference from each of the reconfigurable metasurface unit cells 564 thereby creating the directionality and feed distance necessary to reflect the EM waves towards a receiving device in focused beams 597. Again, this transmission state and direction of the reflected EM waves off of the surface of the metasurface may include the use of constructive and destructive interference to create a focused beam 597 in any of a plurality of specific directions 589. As show in FIG. 5, a direction 589 of the reflected EM waves may be controlled using phase shifting properties to change the direction 589 of the focused beam 597 or multiple focused beams 597 as shown by the individual states (e.g., “State 1,” “State 2,” “State 3,” and “State n”).

During operation, the output from the FPGA 587 or other metasurface controller may be passed through the DAC 585. The DAC 585 may convert any digital signal from the FPGA 587 into an analog signal so that the correct electrical pulse from a power source can be transmitted to a refractory heater or other controllable capacitance structure of reconfigurable metasurface unit cells in order to change the state of a correlated metasurface reconfigurable split ring so as to create the focused beam 597 described herein. In one embodiment, by switching each of the metasurface reconfigurable split rings of each reconfigurable metasurface unit cell 564 of the reconfigurable metasurface unit cell array 562 between the amorphous state and the crystalline state, the reconfigurable metasurface unit cell array 562 may be configured to redirect transmitted EM waves and beam steer those EM waves in a desired direction 589. Additionally, because the heating of the phase change material of the metasurface reconfigurable split rings of the unit cells 564 can be achieved by applying thermal energy such as a pulse of heat with a certain amplitude and width (on the order of nanoseconds) through electrically insulated high-speed heaters, the constant application of power is not needed thereby reducing the need for a dedicated power source. Indeed, in some embodiments, these phase change materials of the metasurface reconfigurable split rings hold their crystalline or amorphous states as long as it is not actuated with another pulse of heat. This allows for the reconfigurable metasurface unit cell array 562 to change, within short periods of time, the directionality of the focused beam 597 or beams 597 among a plurality of directions 589 such that data may be transmitted from a variety of locations, relay by and reflected off of the surface of the reconfigurable metasurface unit cell array 562, and towards a variety of locations. In other embodiments, by switching other controllable capacitance structure of reconfigurable metasurface unit cells 564 of the reconfigurable metasurface unit cell array 562, the reconfigurable metasurface unit cell array 562 may be configured to redirect transmitted EM waves and beam steer those EM waves in a desired direction 589. These embodiments allow for data from locationally distinct transmitting devices to be transmitted to locationally distinct receiving devices using the reconfigurable metasurface unit cell array 562 as an EM wave reflective surface and to include Wi-Fi sensing packets for CSI analysis and beamforming of a virtual LoS link beyond the reconfigurable metasurface unit cell array 562.

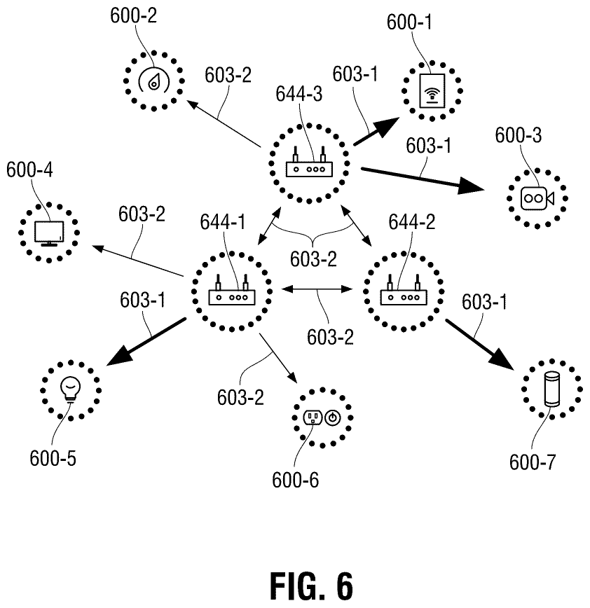

FIG. 6 is a graphic diagram illustrating a Wi-Fi sensing system including both Wi-Fi links between transceiving devices that may implement Wi-Fi sensing systems and Wi-Fi links between transceiving devices that may not implement Wi-Fi sensing systems according to an embodiment of the present disclosure. The Wi-Fi sensing incapable links 603-1 and the Wi-Fi sensing capable links 603-2 may exist based on, for example, the capabilities of those devices present and operating within the environment to conduct Wi-Fi sensing detection and reporting of CSI data, such as CIR phase and amplitude data from a Wi-Fi sense data packet transmitted for channels of a Wi-Fi sensing capable link 603-2 with the Wi-Fi sensing system on both sides of bi-static Wi-Fi sensing described in embodiments herein.

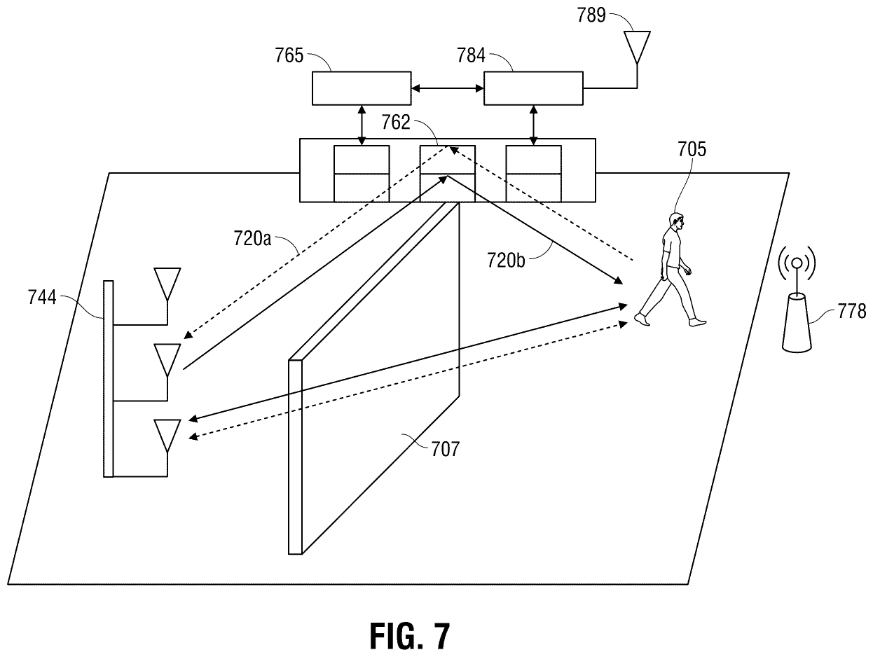

For example, the Wi-Fi sensing capable links 603-2 show a communication between two different devices that may act as both transmitter devices and receiver devices to transceive data using the reconfigurable metasurface unit cell array (not shown in FIG. 6). In an example embodiment, therefore, these Wi-Fi sensing capable links 603-2 may be those links that include hardware device communications that are capable of including and detecting the CSI or CIR data related to the channel distribution between the devices on both sides of those bi-static Wi-Fi sensing capable links 603-2. For example, the Wi-Fi sensing system may include three access points 644-1, 644-2, 644-3 (e.g., wireless routers) that communicate or receive that CSI or CIR data indicating the presence of an object within, movement of that object within, and traversal of that object across the LoS or virtual LoS created between any two of those three access points 644-1, 644-2, 644-3. The virtual LoS for Wi-Fi sensing is not shown in the embodiment of FIG. 6 but would be achieved by the interaction with a reconfigurable metasurface unit cell array and these devices along Wi-Fi sensing capable links 603-2 between them. These virtual LoS paths with a reconfigurable metasurface unit cell array for Wi-Fi sensing are discussed further in FIG. 7 below. Thus, in the embodiment, shown in FIG. 6, each of the access points 644-1, 644-2, 644-3 are shown to include Wi-Fi sensing capable links 603-2 to each other as well as a number of additional Wi-Fi sensing capable information handling systems 600-2, 600-4, 600-6. This may allow each of the access points 644-1, 644-2, 644-3 and Wi-Fi sensing capable information handling systems 600-2, 600-4, 600-6 to operate in a bistatic manner thereby detecting objects within, moving within, and traversing the LoS wireless link channels, or virtual LoS wireless link extensions as in FIG. 7 formed by a reconfigurable metasurface unit cell array, therebetween Wi-Fi sensing capable transmitter devices and receiver devices.

However, for reasons such as deficient hardware capabilities of the non-Wi-Fi sensing capable information handling systems 600-1, 600-3, 600-5, 600-7, this CIR data or CSI may not be transmittable to the non-Wi-Fi sensing capable information handling systems 600-1, 600-3, 600-5, 600-7. Thus, although the access points 644-1, 644-2, 644-3 may communicate with those non-Wi-Fi sensing capable information handling systems 600-1, 600-3, 600-5, 600-7, the CSI or CIR data may not be relayed from the non-Wi-Fi sensing capable information handling systems 600-1,600-3, 600-5, 600-7. However, in some embodiments, the operation of the access points 644-1, 644-2, 644-3 and other Wi-Fi sensing capable information handling systems 600-2, 600-4, 600-6 in transmitting data to these non-Wi-Fi sensing capable information handling systems 600-1, 600-3, 600-5, 600-7 may still be used to detect objects moving within, and traversing the virtual LoS channel formed by the reconfigurable metasurface unit cell array relaying data to and from the non-Wi-Fi sensing capable information handling systems 600-1, 600-3, 600-5, 600-7 in a monostatic manner.

FIG. 7 is a graphic diagram illustrating an environment in which the reconfigurable metasurface unit cell array 762 may be deployed in order to create a virtual LoS channel and implement a Wi-Fi sensing system with extended range and directionality with that virtual LoS channel 720b of a Wi-Fi wireless link 720a and 720b according to an embodiment of the present disclosure. As described herein, the information handling system may include any type of information handling system such as the access point 774 shown in FIG. 7. In an embodiment, the access point 774 may wirelessly communicate with a target receiver device 778 via the reconfigurable metasurface unit cell array 762. The receiver device 778 may be any other device and may include the AP, the base station, or any other computing device described herein. Additionally, the access point 774 and receiver device 778 may be capable of transmitting wireless data using, for example, EM waves that include Wi-Fi wavelengths such as 2.4 GHz, 5GHz, 6 GHz or others to be used with later versions of WiFi. Thus, in an embodiment, the reconfigurable metasurface unit cell array 762 is capable of relaying these types of mm waves. This reconfigurable metasurface unit cell array 762 may be configured to relay or otherwise reflect wireless EM waves transmitted from, for example, an access point 774 or other transmitting information handling system and may extend the wireless range or improve signal of access point 774 other transmitting device in communications with a target wireless device such as the receiving device 778.

It is appreciated that the reconfigurable metasurface unit cell array 762 may include any type of metasurface technology that may be used to receive and reflect transmitted EM waves of a wireless link 720a and 720b from a transmitter device to a receiver device. For example, as described herein, the reconfigurable metasurface unit cell array 762 may include any type of capacitive reconfigurable metasurface unit cell that incorporates varactor diodes, capacitor banks, integrated switch capacitors, monolithic phase delay elements, and/or monolithic phase shifters. In a specific embodiment, the reconfigurable metasurface unit cell array 762 may include an array of rings of phase change material or non-volatile phase change material that, when heated, may be transformed between two distinct states: an amorphous state and a crystalline state such as those described in connection with FIGS. 2 and 3 for example.

The reconfigurable metasurface unit cell array 762 may include a plurality of reconfigurable metasurface unit cells. It is appreciated that the reconfigurable metasurface unit cell array 762 may contain any number of reconfigurable metasurface unit cells. In one example embodiment, the reconfigurable metasurface unit cell array 762 may contain two-hundred and fifty-six reconfigurable metasurface unit cells arranged in a sixteen-by-sixteen array. It is appreciated that the reconfigurable metasurface unit cell array 762 may include any plurality of reconfigurable metasurface unit cells in any arrangement of those unit cells. As described herein, the reconfigurable metasurface unit cells within the reconfigurable metasurface unit cell array 762 may be used to, in real-time, to reconfigure its reflective properties to control the refection and steering of incoming EM waves of a Wi-Fi wireless link 720a and 720b from a transmitting source (e.g., the wireless antenna of the access point 774 or other transmitter device) to a receiver device 778 according to embodiments herein.

The Wi-Fi sense packet on one or more channels of the Wi-Fi wireless link 720a and 720b includes CSI information and relayed back to the transmitter device to inform the transmitter device 744 about objects 705 that have entered, are present, and/or are moving through the virtual LoS channel 720b between the reconfigurable metasurface unit cell array 762 and the receiver device 778 in an embodiment when operating bi-static Wi-Fi sensing. In an embodiment, the reconfigurable metasurface unit cell array 762 may include a reconfigurable metasurface MCU that is responsible to execute computer-readable program code instructions of a NLoS sense signal phase profile control system to monitor for angle of arrival of time of flight in a Wi-Fi communication channel of a Wi-Fi wireless link 720a and 720b indicative of a target object 705 present within the virtual LoS path 720b of the wireless link 720a and 720b beyond the reconfigurable metasurface unit cell array 762 as reflected towards the receiver device 778. This angle of arrival and time of flight detected from the target object 705 in the virtual LoS path portion 720b of the wireless link 720a and 720b is used to determine beamforming pattern direction and location adjustments to the reconfigurable metasurface unit cell array 762 to the target object 705 in embodiments herein for improvement of the Wi-Fi sensing by the transmitter access point 744 in an NLoS region behind obstacle 707. Further, the beamforming pattern direction and location information of the target object 705 are transmitted by the reconfigurable metasurface unit cell array 762 to the transmitter device access point 744 in embodiments herein.

In other embodiments, plural antennas on the access point 744 may transmit and receive a signal that is reflected off of the reconfigurable metasurface unit cell array 762 to target object 705 with monostatic Wi-Fi sensing from the same access point 744 location. The reconfigurable metasurface unit cell array 762 extends the range of this transmission and reception via a reflection such that an object 705 in the extended virtual LoS channel may be detected the CSI information by Wi-Fi sensing at the transmitter device access point 744. Further, the reconfigurable metasurface unit cell array 762 may determine beamforming pattern direction and location adjustments to the target object 705 and transmit the same back to the access point 744.

In an embodiment, the reconfigurable metasurface MCU may use backscatter signals that are received at the reconfigurable metasurface unit cell array 762 and reflected back to the transmitting access point 744 in order to transmit this beamforming pattern direction and location information of the target object 705 back to a transmitting device access point 744 conducting Wi-Fi sensing. Where, for example, the reconfigurable metasurface MCU discovers that an EM wave signal exhibits angle of arrival and time of flight in echo signals of a target object in a Wi-Fi wireless link 720a and 720b at the virtual LoS portion 720b, the reconfigurable metasurface MCU may also execute computer-readable program code instructions of a non-LoS sense signal phase backscatter system to create an encoded signal modulated within a reflected or relayed signal sent back to the transmitter device access point 744 to report the beamforming pattern direction and location information of the target object 70 to the transmitter device to be used with the detected CSI channel characteristics in Wi-Fi sensing of the target object 705 or to conduct any beamforming directionality at the transmitter device access point 744 to further assist Wi-Fi sensing.

In another embodiment, the reconfigurable metasurface MCU may use a side band communication process in order to transmit this beamforming pattern direction and location information of the target object 705 to the transmitter device access point 744 conducting Wi-Fi sensing. Thus, in an embodiment, the reconfigurable metasurface MCU may be operatively coupled to a reconfigurable metasurface wireless interface adapter that includes a radio, an RF front end, and a reconfigurable metasurface antenna 789 that supports the creation and use of this side band channel to communicate with the transmitter device access point 744.

In an embodiment, the channel state information (CSI) may include channel impulse response (CIR) amplitude or phase shift data including expected or unexpected path loss characteristics such as from scatter, fading, power decay, delay spread, multipath components, amplitude changes or the like in the Wi-Fi sensing. Changes to this CIR amplitude or phase shift profile from that of an empty room, for example, may indicate the presence of a target object 705 such as a person in the Wi-Fi sensed wireless link 720a and 720b and in particular to the virtual LoS portion 720b. This reconfigurable metasurface unit cell array 762 extends to the virtual LoS portion 720b of wireless link 720a and 720b beyond an obstacle 707 such as a wall. This CSI and/or CIR data may inform the devices within the environment including the transmitter device and the receiver device 778 of those target objects 705 within the environment that are within, passing through, and moving with the virtual LoS path portion 720b of the wireless link 720a and 720b. In an embodiment, the CSI and CIR data may be in reference to either bistatic or monostatic detection of an object within the environment that the reconfigurable metasurface unit cell array 762 is placed.

FIG. 7 shows the detection of either a bistatic or monostatic configuration of the use of the reconfigurable metasurface unit cell array 762. FIG. 7 shows the presence and/or movement of a human object 705 within the virtual LoS portion 720b as well as the known presence of other obstacles such as a wall 707. The wall 707 being present in between the access point 774 and the receiver device 778 may suggest a reason as to why the reconfigurable metasurface unit cell array 762 is placed at a surface positioned to relay transmissions from the access point 774 to the receiver device 778 via reflected wireless link 720a and 720b to include the virtual LoS portion 720b. In embodiments herein, the reconfigurable metasurface unit cell array 762 may dynamically adjust the beamforming reconfigurable metasurface directionality or detect directionality of the virtual LoS portion 720b of wireless link 720a and 720b to better sense the object 705, such as a human. Additionally, location information may be determined and transmitted based on received strength of lobes or reception of a return signal. This beamforming adjustment directionality may provide additional data reported back to the transmitting device access point 744 conducting Wi-Fi sensing in some embodiments herein. This beamforming adjustment directionality may be additional phase information sent back with the CSI data for the channel on the Wi-Fi wireless link for Wi-Fi sensing in embodiments herein.

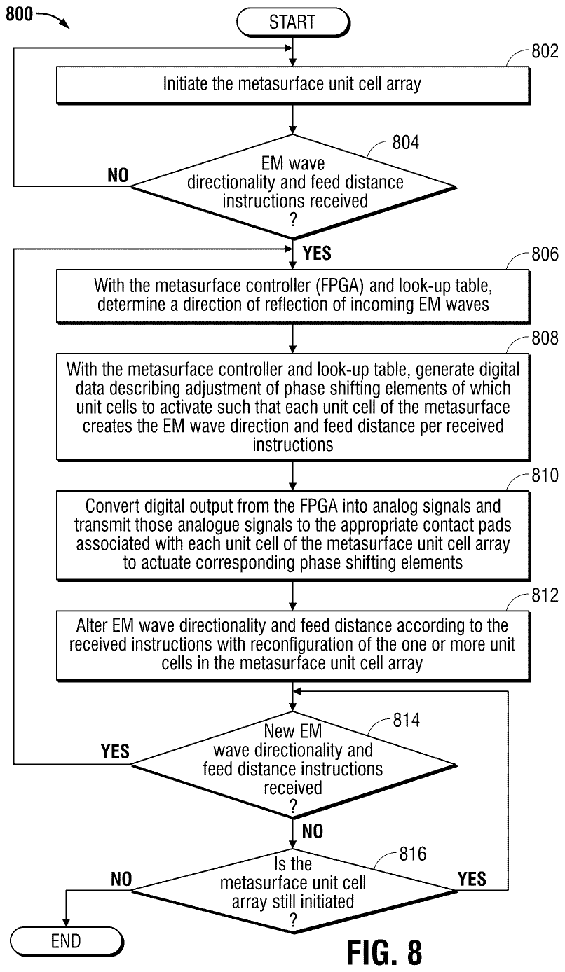

FIG. 8 is a block diagram of a method 800 controlling a metasurface unit cell array to dynamically change the directionality and feed distance of reflected EM wave beams for radiofrequency communications according to an embodiment of the present disclosure. The reconfigurable metasurface unit cell array used in this method may be similar to those reconfigurable metasurface unit cell arrays described in connection with, for example, FIGS. 2 and 3. It is appreciated that any type of capacitive unit cell that incorporates varactor diodes, capacitor banks, integrated switch capacitors, monolithic phase delay elements, and/or monolithic phase shifters may also be used in the reconfigurable metasurface unit cell array as described herein. In an embodiment, the reconfigurable metasurface unit cell array may include a plurality of reconfigurable metasurface unit cells that are individually controlled using a metasurface PMU or power source, a metasurface controller such as an FPGA, and DAC or other components as described herein.

At block 802, the method 800 may include initiating the reconfigurable metasurface unit cell array. In an embodiment, the reconfigurable metasurface unit cell array may be initiated by a user actuating a power button on the reconfigurable metasurface unit cell array. The metasurface PMU may then proceed to power a metasurface controller such as an FPGA and DAC in order to receive EM wave directionality and feed distance instructions or to detect from the reconfigurable metasurface unit cell array directionality and feed distance of a source wireless device and of a target receiving wireless device. In an embodiment, the reconfigurable metasurface unit cell array may be placed on a surface where EM waves may be reflected off from a source wireless device in order to reach a receiving device. These surfaces may include a wall and a side of a building, among other surfaces in a radiofrequency environment where millimeter EM waves may be relayed around objects that would otherwise prevent penetration.

At block 804, the method 800 may include determining whether an EM wave directionality and feed distance instructions have been received or detected between the source wireless device and the target receiving wireless device. In an embodiment, these EM wave directionality and feed distance instructions may be provided via a wireless connection from, for example, a transmitting wireless information handling system or other source wireless computing device that is provided data descriptive of the radiofrequency environment in which the transmitting source wireless computing device and receiving wireless device are located. For example, the radiofrequency environment may include an office building setting where the walls of the individual rooms and offices prevent such short wavelengths from passing through to other wireless devices. In other embodiments, the reconfigurable metasurface unit cells may operate as an array antenna to detect wireless signal directionality from the source wireless computing device and to the target receiving wireless device and provide this to the metasurface controller or other hardware controller to determine wave directionality and feed distance instructions for adjustment. The EM wave directionality and feed distance instructions, in an embodiment, may include location data or direction detected of a receiving wireless device such as a receiving wireless information handling system, an access point, a base station, and the like. Where no EM wave directionality and feed distance instructions have been received, the wireless controller FPGA and DCA do not change any directionality and feed distance characteristics of the reconfigurable metasurface unit cell array and the reconfigurable metasurface unit cell array continues in its current state with the metasurface reconfigurable rings in their current amorphous state or crystalline state or controllable capacitance structures remaining in their current capacitive state for the reconfigurable metasurface unit cells.

However, where the EM wave directionality and feed distance instructions have been received, the method 800 continues to block 806. At block 806, the method 800 further includes determining a direction of reflection of incoming EM waves with the metasurface controller FPGA and a look-up table accessible to the metasurface FPGA. This look-up table may be maintained on a non-volatile memory device associated with and accessible to the metasurface controller FPGA so that the FPGA may generate appropriate digital signals such that the directionality and feed distance may be replicated at the reconfigurable metasurface unit cell array according to the received EM wave directionality and feed distance instructions.

Thus, at block 808, the method 800 also includes generating digital data, as output from the metasurface controller FPGA, describing which reconfigurable metasurface unit cells to activate such that each of the reconfigurable metasurface unit cells create the EM wave direction and feed distance beam directionality per the received EM wave directionality and feed distance instructions.

At block 810, the method 800, therefore, includes converting digital output from the metasurface controller FPGA into analog signal and power via the DAC and a power source and transmitting those analogue signals and power to the appropriate reconfigurable metasurface unit cells associated with the reconfigurable metasurface unit cell array. Thus, at block 812, as a result of the analog signals from the DAC being transmitted, the EM wave directionality and feed distance are altered according to the originally received EM wave directionality and feed distance instructions. Again, the reconfigurable metasurface unit cells may be used to invoke constructive and/or destructive interference in the reconfigurable metasurface unit cell array in directions such that a beam lobe is created that is directed towards or focused towards a receiving wireless device.

At block 814, the method 800 continues by detecting whether a new set of EM wave directionality and feed distance instructions have been received or detected at the metasurface controller FPGA. Where a new set of EM wave directionality and feed distance instructions have been received or detected from a source wireless device, the method 800 continues to block 806 with the metasurface controller FPGA executing those processes described herein. Where no new EM wave directionality and feed distance instructions have been received, the method 800 continues to block 816.

At block 816, the method 800 includes determining if the reconfigurable metasurface unit cell array is still initiated. Where the reconfigurable metasurface unit cell array is still initiated, the method 800 proceeds to block 814 with the FPGA monitoring to determine if new EM wave directionality and feed distance instructions have been received as described herein. Where the reconfigurable metasurface unit cell array is no longer initiated, the method 800 may end here.

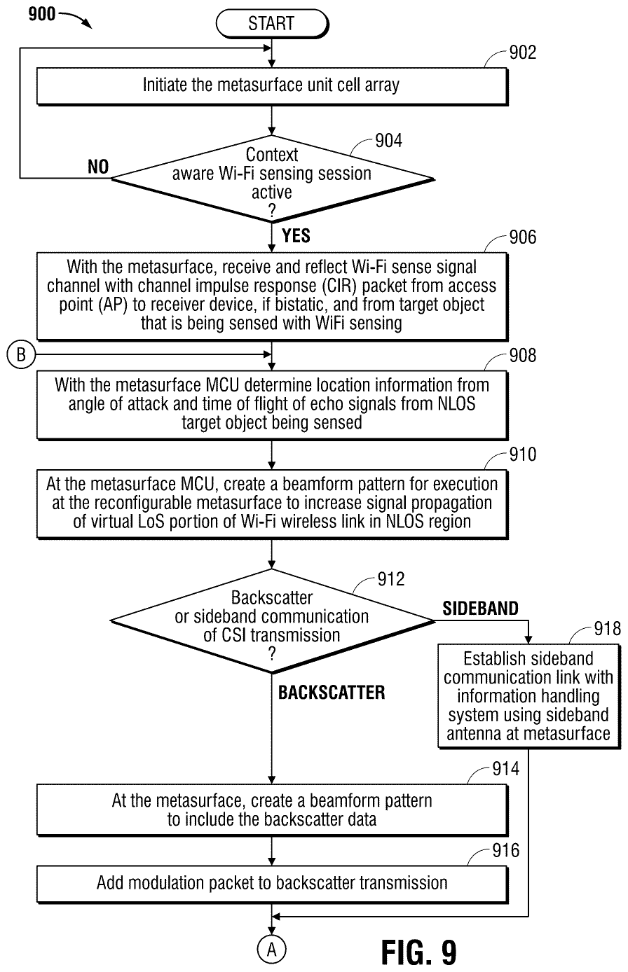

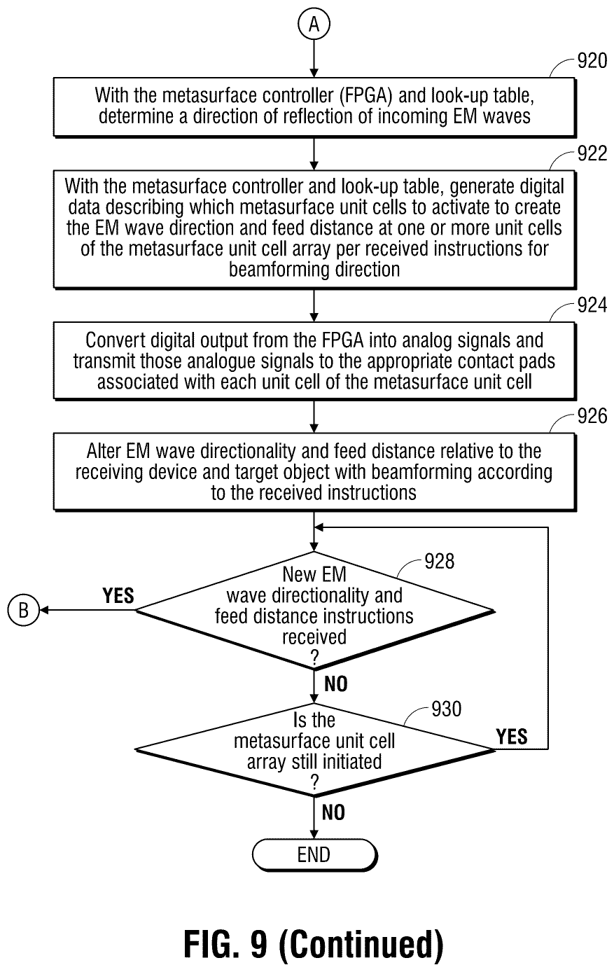

FIG. 9 is a block diagram of a method 900 of operating a virtual LoS Wi-Fi sensing system via deployment of a reconfigurable metasurface unit cell array according to an embodiment of the present disclosure. This method 900 may be executed by the reconfigurable metasurface unit cell array in operative communication with, for example, one or more information handling systems such as an AP, a laptop, a tablet device, or any other information handling system conducting Wi-Fi sensing described in connection with, for example, embodiments of FIGS. 1 and 6.

At block 902, the method 900 may include initiating the reconfigurable metasurface unit cell array. In an embodiment, the reconfigurable metasurface unit cell array may be initiated by a user actuating a power button on the reconfigurable metasurface unit cell array. The metasurface PMU may then proceed to power a metasurface controller such as an FPGA and DAC in order to receive EM wave directionality and feed distance instructions or to detect from the reconfigurable metasurface unit cell array directionality and feed distance of a source wireless signal of a source wireless device or from a reflected signal of a target receiving wireless device or a target object in the path of the wireless link. In an embodiment, the reconfigurable metasurface unit cell array may be placed on a surface where EM waves of a Wi-Fi wireless link may be reflected off from a source wireless device in order to reach a receiving device. These surfaces may include a wall and a side of a building, among other surfaces in a radiofrequency environment where millimeter EM waves may be relayed around a barrier to a non-line-of-sight region that would otherwise prevent penetration.

At block 904, the method 900 may continue with determining if the context aware Wi-Fi sensing session is active or not. For example, during operation of a transmitter device such as an information handling system, the hardware processor may execute computer-readable program code of a Wi-Fi sensing detection system. The Wi-Fi sense detection system may, among other tasks, relay signals to the reconfigurable metasurface unit cell array indicating that a context aware Wi-Fi sensing session is active. This Wi-Fi sensing session may, when activated, monitor for certain data from a Wi-Fi wireless link with a receiver wireless device via reflection from the reconfigurable metasurface unit cell array that may indicate that a target object such as a human is within, is moving within, and/or is passing through a virtual LoS portion of the Wi-Fi wireless link created between the information handling system 100, the reconfigurable metasurface unit cell array, and the receiver device. As described herein, this may come in the form of propagation loss data that includes CSI and/or CIR data from a Wi-Fi sensing packet detecting channel characteristics of impulse phase changes or amplitude changes in channels of the Wi-Fi wireless link caused by a target object relative to without the target object present. This CSI and/or CIR data may inform the transmitting device information handling system, or the receiving information handling system within the environment of any target objects within the environment that are within, passing through, and moving with the virtual LoS path portion of the Wi-Fi wireless link. In an embodiment, the CSI and CIR data may be in reference to either bistatic or monostatic detection of an object within the environment that the reconfigurable metasurface unit cell array is placed, such that the transmitting wireless device may also be the location of the receiver and the Wi-Fi wireless link is bounced off of the reconfigurable metasurface unit cell array with an extension into the virtual LoS path portion of the Wi-Fi wireless link.

The reconfigurable metasurface MCU of the reconfigurable metasurface unit cell array may, therefore, monitor for changes in the propagation data. Thus, at block 906, the method 900 includes the reconfigurable metasurface unit cell array receiving and reflecting Wi-Fi sense signal channel that includes CIR packets from an transmitter device to receiver device, if bistatic, and including an echo signal from the target object that is being sensed with Wi-Fi sensing in the virtual LoS path portion of the Wi-Fi wireless link. This data may be transmitted to, for example, the Wi-Fi sense detection system executing at a transmitter information handling system to process, for example for differences from empty room channel characteristics to identify the target object is present. For example, the Wi-Fi sense detection system of the transmitter device (e.g., the information handling system) may cause that computer-readable program code instructions of a channel state information analysis target detection module be executed to process any return CSI propagation data reflected back by the reconfigurable metasurface unit cell array as well as any detected beamforming phase shift or location of the target object detected by and transmitted from the reconfigurable metasurface MCU in beamforming the reconfigurable metasurface unit cell array towards the target object.

At this point, the method 900 also includes, at block 908, the metasurface MCU determining location information from the angle of arrival and time of flight of an echo signal from the target object in the NLoS region being sensed within the virtual LoS channels of the Wi-Fi wireless link. This data may include detecting phase, amplitude, or frequency of the reflected signals off of the intermediary target object such as the human in FIG. 6 to determine a beamforming directionality and location by the reconfigurable metasurface unit cell array in embodiments herein.

At block 910, the method 900 includes, at the metasurface MCU creating a beamform pattern for execution at the reconfigurable metasurface to increase signal propagation of the Wi-Fi wireless link conducting Wi-Fi sensing to the target object within the virtual LoS portion of the Wi-Fi wireless link. As described herein, the reconfigurable metasurface unit cell array may include any type of metasurface technology that may be used to receive and reflect transmitted EM waves from a transmitter device to a receiver device. For example, as described herein, the reconfigurable metasurface unit cell array may include any type of capacitive unit cell that incorporates varactor diodes (e.g., commercial-off-the-shelf (COTS) varactor diodes), capacitor banks (e.g., COTS capacitor banks), integrated switch capacitors, monolithic phase delay elements, and/or monolithic phase shifters. In a specific embodiment, the reconfigurable metasurface unit cell array may include an array of rings of phase change material or non-volatile phase change material that, when heated, may be transformed between two distinct states: an amorphous state and a crystalline state to alter reflective capacitance of each reconfigurable metasurface unit cell. The reconfigurable metasurface unit cell array of an embodiment described herein may include this array of rings of non-volatile phase change material that, when heated, may be transformed between two distinct states: an amorphous state and a crystalline state altering conductivity of those rings and the capacitance of the reconfigurable metasurface unit cell.

The reconfigurable metasurface unit cell array may include a plurality of reconfigurable metasurface unit cells, such as the first reconfigurable metasurface unit cell and a second reconfigurable metasurface unit cell is shown in FIG. 1 as well as those reconfigurable metasurface unit cells shown and described in FIGS. 2 and 3. It is appreciated that the reconfigurable metasurface unit cell array may contain any number of reconfigurable metasurface unit cells. In one example embodiment, the reconfigurable metasurface unit cell array may contain two-hundred and fifty-six reconfigurable metasurface unit cells arranged in a sixteen-by-sixteen array. It is appreciated that the reconfigurable metasurface unit cell array may include any plurality of reconfigurable metasurface unit cells in any arrangement of those unit cells. As described herein, the reconfigurable metasurface unit cells within the reconfigurable metasurface unit cell array may be used to, in real-time, to reconfigure its reflective properties to control the refection and steering of incoming EM waves from a transmitting source (e.g., the wireless antenna of the wireless interface adapter of the information handling system, an AP, or other transmitter device) to a receiver device according to embodiments herein. Adjustment of reflective capacitance properties of the one or more reconfigurable metasurface unit cells of the reconfigurable metasurface unit cell array is made according to a beamforming pattern determined by the reconfigurable metasurface MCU from angle of arrival and time of flight information of the received echo signals of the target object and the receiver information handling system within the virtual LoS portion of the Wi-Fi wireless link in embodiments herein. The beamforming pattern determined includes directionality and location information of the target object within the virtual LoS portion of the Wi-Fi wireless link.

At block 912, the method may include the reconfigurable metasurface MCU determining whether to implement backscatter processing or use a sideband communication channel in order to transmit beamforming pattern directionality and location information of the target object within the virtual LoS portion of the Wi-Fi wireless link to the transmitting device as described herein. Again, when the reconfigurable metasurface MCU has been instructed that a Wi-Fi sensing session has commenced, the reconfigurable metasurface MCU may determine beamforming pattern directionality and location of a target object and execute computer-readable program code instructions of a non-LoS sense signal phase backscatter system to create an modulated signal having the beamforming pattern directionality and location information of the target object, modulated on backscatter signal from the reconfigurable metasurface unit cell array to the transmitter information handling system device. In one example embodiment, the modulated signal with the beamforming pattern directionality and location information of the target object may be modulated on a relayed signal sent back to the transmitter device to report the detected channel characteristics to the transmitter device. In an embodiment, the encoded signal of the beamforming pattern directionality and location information of the target object may include the non-LoS sense signal phase backscatter system implementing modulation techniques such as binary phase shift keying (BPSK) or amplitude shift keying (ASK) such that the reconfigurable metasurface unit cell array switches between different states or phase shifts that are meant to represent binary output (e.g., 0s and 1s) to adjust a backscatter signal. In an embodiment, at block 914, the reconfigurable metasurface MCU may calculate this backscatter data and modulate the phase shift information of the beamforming pattern directionality and location information of the target object within the virtual LoS portion of the Wi-Fi wireless link directly into the backscattered signal by modulating the phase of the reflected wave of the backscatter signal. Thus, at block 916, the method 900 includes the reconfigurable metasurface MCU adding this modulation packet to the backscatter transmission made to the transmitter device such as the information handling system.

However, where at block 912, the reconfigurable metasurface MCU identifies that a side band channel is to be used to transmit the beamforming pattern directionality and location information of the target object within the virtual LoS portion of the Wi-Fi wireless link, the reconfigurable metasurface MCU may address a reconfigurable metasurface wireless interface adapter that includes a radio, an RF front end, and a reconfigurable metasurface antenna that supports the creation and use of this side band channel to communicate with the transmitter device. A decision as to whether to use the backscatter method or the side band communication channel may depend on whether a reconfigurable metasurface wireless interface adapter is available at the reconfigurable metasurface unit cell array or not, or whether an original signal from the information handling system sent at block 904 indicates a selected method.

In the example where the side band communication channel is selected at block 912, the method 900 proceeds to block 918 with the reconfigurable metasurface MCU of the reconfigurable metasurface unit cell array establishing a sideband communication link with the information handling system or even with a plurality of information handling systems. The reconfigurable metasurface MCU may transmit this beamforming pattern directionality and location information of the target object on the sideband communication link to the transmitter device. The transmitter device may use this data for further Wi-Fi sensing information or to further beamform its own EM waves of the Wi-Fi wireless link being used for Wi-Fi sensing. In an embodiment, this sideband communication link may include security measures used to ensure that the reconfigurable metasurface unit cell array is a trusted device with the information handling systems. Additionally, the reconfigurable metasurface wireless interface adapter 184 may establish a Bluetooth® or another Wi-Fi link with the transmitter device.

The method 900 may also include, at block 920, determining a beamforming direction of reflection for the incoming EM waves of the Wi-Fi wireless link with Wi-Fi sensing with the metasurface controller FPGA and a look-up table accessible to the metasurface FPGA. This look-up table may be maintained on a non-volatile memory device associated with and accessible to the metasurface controller FPGA so that the FPGA may generate appropriate digital signals such that the directionality and feed distance may be replicated at the reconfigurable metasurface unit cell array according to the received EM wave directionality and feed distance instructions for the determined beamforming pattern including directionality and location information of the target object within the virtual LoS portion of the Wi-Fi wireless link.

Thus, at block 922, the method 900 also includes generating digital data, as output from the metasurface controller FPGA, describing which reconfigurable metasurface unit cells to activate such that each of the reconfigurable metasurface unit cells create the EM wave direction and feed distance beam directionality per the received EM wave directionality and feed distance instructions for the determined beamforming pattern including directionality and location information of the target object within the virtual LoS portion of the Wi-Fi wireless link.

At block 924, the method 800, therefore, includes converting digital output from the metasurface controller FPGA into analog signal and power via the DAC and a power source and transmitting those analogue signals and power to the appropriate reconfigurable metasurface unit cells associated with the reconfigurable metasurface unit cell array. Thus, at block 926, as a result of the analog signals from the DAC being transmitted, the EM wave directionality and feed distance are altered according to the received EM wave directionality and feed distance instructions for the determined beamforming pattern including directionality and location information of the target object within the virtual LoS portion of the Wi-Fi wireless link. Again, the reconfigurable metasurface unit cells may be used to invoke constructive and/or destructive interference in the reconfigurable metasurface unit cell array in directions such that a beam lobe is created that is directed towards or focused towards the target object and a receiving wireless device.

At block 928, the method 800 continues by detecting whether a new set of EM wave directionality and feed distance instructions have been received or detected at the metasurface controller FPGA. Where a new set of EM wave directionality and feed distance instructions have been received or detected from a source wireless device, the method 900 continues to block 908 with the metasurface controller FPGA executing those processes described herein. Where no new EM wave directionality and feed distance instructions have been received, the method 900 continues to block 930.

At block 930, the method 900 includes determining if the reconfigurable metasurface unit cell array is still initiated. Where the reconfigurable metasurface unit cell array is still initiated, the method 900 proceeds to block 928 with the FPGA monitoring to determine if new EM wave directionality and feed distance instructions have been received as described herein. Where the reconfigurable metasurface unit cell array is no longer initiated, the method 900 may end here.

The processes or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A reconfigurable metasurface unit cell array of a virtual line-of-sight (LoS) WiFi sensing system comprising:
the reconfigurable metasurface unit cell array to reflect a wireless link between a transmitter device and receiver device with a virtual line-of-sight (LoS) portion between the reconfigurable metasurface unit cell array and the receiver device to relay an electromagnetic (EM) wave along a non-line-of-sight (NLoS) path region between the transmitter device and receiver device;
a reconfigurable metasurface microcontroller unit (MCU) to receive and reflect a Wi-Fi sensing request via the wireless link from the transmitter device;
the reconfigurable metasurface MCU execute computer-readable program code of a NLoS sense signal phase profile control system to monitor for propagation loss indicative of an echo signal of a target object present within the virtual LoS portion of the wireless link;
the reconfigurable metasurface MCU to determine a location of the object within the virtual LoS portion based on beamforming from angle of arrival and time of flight of the echo signal detected at the reconfigurable metasurface unit cell array and beamform with reconfiguration of reconfigurable metasurface unit cells in the reconfigurable metasurface unit cell array towards the location of the target object to improve the sensing of the echo signal detected channel characteristics reported for the wireless link including the virtual LoS portion returned to the transmitting device; and
the reconfigurable metasurface MCU to wirelessly report the detected beamforming phase shift or location information of the target object to the transmitter device conducting Wi-Fi sensing.

2. The reconfigurable metasurface unit cell array of claim 1 further comprising:
the reconfigurable metasurface unit cells including plural metasurface reconfigurable split rings with corresponding refractory heaters to switch the corresponding metasurface reconfigurable split ring between a conductive state and dielectric state to adjust capacitance of the reconfigurable metasurface unit cell;
and the reconfigurable metasurface MCU to selectively provide power to some portion of the plural refractory heaters to change the electromagnetic reflective properties of the array of reconfigurable metasurface unit cells to conduct beamforming.

3. The reconfigurable metasurface unit cell array of claim 1 further comprising:
the reconfigurable metasurface unit cells including plural metasurface switchable capacitance structures to switch the corresponding capacitance of the reconfigurable metasurface unit cell; and
the reconfigurable metasurface MCU to selectively switch some portion of the capacitance of the reconfigurable metasurface unit cells to change the electromagnetic reflective properties of the reconfigurable metasurface unit cell array to conduct beamforming.

4. The reconfigurable metasurface unit cell array of claim 1 further comprising:
the reconfigurable metasurface MCU to execute computer-readable program code of a NLoS sense signal phase backscatter system to create a modulated signal within a backscatter signal sent back to the transmitter device to report the detected beamforming phase shift or location of the target object to the transmitter device.

5. The reconfigurable metasurface unit cell array of claim 1 further comprising:
the reconfigurable metasurface MCU to establish a side band communication with the transmitter device, via a reconfigurable metasurface antenna and radio, to report the detected beamforming phase shift or location of the target object to the transmitter device.

6. The reconfigurable metasurface unit cell array of claim 1 further comprising:
the detected channel characteristics including channel state information describing how the EM wave is transmitted between each of the transmitter device and receiver device in terms of amplitude and phase.

7. The reconfigurable metasurface unit cell array of claim 1, wherein the echo signal detected channel characteristics reported for the wireless link including the virtual LoS portion returned to the transmitting device includes channel impulse response data describing how an impulse signal transmitted by the transmitter device and relayed by the reconfigurable metasurface unit cell array propagates through a channel along the virtual LoS portion of the wireless link for details related to delay spread, multipath components, and amplitude.

8. The reconfigurable metasurface unit cell array of claim 1 further comprising:
a metasurface controller field programmable gate array (FPGA) to access a look-up table defining how the metasurface controller FPGA is to activate each of the reconfigurable metasurface unit cells of the reconfigurable metasurface unit cell array to create destructive or constructive interference to create directionality and feed distance as the EM wave is reflected towards the target object to conduct beamforming.

9. The reconfigurable metasurface unit cell array of claim 1 further comprising:
the reconfigurable metasurface MCU to execute computer-readable program code of a NLoS sense signal phase backscatter system to create an encoded signal, via a binary phase shift keying (BPSK) algorithm or amplitude shift keying (ASK) algorithm, within a relayed signal sent back to the transmitter device to report the detected channel characteristics to the transmitter device.

10. A reconfigurable metasurface unit cell array of a virtual line-of-sight (LoS) Wi-Fi sensing system comprising:
the reconfigurable metasurface unit cell array to reflect a wireless link between a transmitter device and receiver device with a virtual line-of-sight (LoS) portion between the reconfigurable metasurface unit cell array and the receiver device to relay an electromagnetic (EM) wave along a non-line-of-sight (NLoS) path region between the transmitter device and receiver device;
a reconfigurable metasurface microcontroller unit (MCU) to receive and reflect a Wi-Fi sensing request via the wireless link from the transmitter device;
the reconfigurable metasurface MCU execute computer-readable program code of a NLoS sense signal phase profile control system to monitor for an echo signal of a target object present within the virtual LoS portion of the wireless link;
the reconfigurable metasurface MCU to determine a location of the target object within the virtual LoS portion based on beamforming from angle of arrival and time of flight of the echo signal detected at the reconfigurable metasurface unit cell array;
the reconfigurable metasurface MCU to instruct switching of adjustable capacitance of a plurality of reconfigurable metasurface unit cells in the reconfigurable metasurface unit cell array to create destructive or constructive interference for directionality and feed distance to beamform the EM waves of the wireless link with the virtual LoS portion towards the location of the target object;
the reconfigurable metasurface array to reflect back sensing of echo signal detected channel statistical information (CSI) characteristics for the wireless link including the virtual LoS portion to the transmitting device for Wi-Fi sensing; and
the reconfigurable metasurface MCU to wirelessly report the detected beamforming phase shift or location information of the target object to the transmitter device conducting Wi-Fi sensing.

11. The reconfigurable metasurface unit cell array of claim 10 further comprising:
the reconfigurable metasurface unit cells including plural metasurface reconfigurable split rings with corresponding refractory heaters to switch the corresponding metasurface reconfigurable split ring between a conductive state and dielectric state to switch the adjustable capacitance of the reconfigurable metasurface unit cell; and
and the reconfigurable metasurface MCU to selectively provide power to some portion of the plural refractory heaters to change the electromagnetic reflective properties of the array of reconfigurable metasurface unit cells to conduct the beamforming.

12. The reconfigurable metasurface unit cell array of claim 10 further comprising:
the reconfigurable metasurface MCU to execute computer-readable program code of a NLoS sense signal phase backscatter system to create a modulated signal within a backscatter signal sent back to the transmitter device to report the detected beamforming phase shift or location of the object to the transmitter device.

13. The reconfigurable metasurface unit cell array of claim 10 further comprising:
the reconfigurable metasurface MCU to establish a side band communication with the transmitter device, via a reconfigurable metasurface antenna and radio, to report the detected beamforming phase shift or location of the target object to the transmitter device.

14. The reconfigurable metasurface unit cell of claim 10 further comprising:
the reconfigurable metasurface MCU to execute computer-readable program code of a NLoS sense signal phase backscatter system to create a modulated signal reporting the detected beamforming phase shift or location of the target object, via a binary phase shift keying (BPSK) algorithm or amplitude shift keying (ASK) algorithm, on a relayed signal sent back to the transmitter device with the sensing of echo signal detected CSI characteristics for the wireless link including the virtual LoS portion.

15. A reconfigurable metasurface unit cell array of a virtual line-of-sight (LoS) Wi-Fi sensing system comprising:
the reconfigurable metasurface unit cell array to reflect a wireless link between a transmitter device and receiver device with a virtual line-of-sight (LoS) portion between the reconfigurable metasurface unit cell array and the receiver device to relay an electromagnetic (EM) wave along a non-line-of-sight (NLoS) path region between the transmitter device and receiver device;
a reconfigurable metasurface microcontroller unit (MCU) to receive and reflect a Wi-Fi sensing request via the wireless link from the transmitter device;
the reconfigurable metasurface MCU execute computer-readable program code of a NLoS sense signal phase profile control system to monitor for an echo signal of a target object present within the virtual LoS portion of the wireless link;
the reconfigurable metasurface MCU to determine a location of the object within the virtual LoS portion based on beamforming from angle of arrival and time of flight of the echo signal detected at the reconfigurable metasurface unit cell array;
the reconfigurable metasurface MCU to instruct switching of adjustable capacitance of a plurality of reconfigurable metasurface unit cells in the reconfigurable metasurface unit cell array to beamform the wireless link with the virtual LoS portion towards the location of the target object;
the reconfigurable metasurface array to reflect back sensing of echo signal detected channel statistical information (CSI) characteristics for the wireless link including the virtual LoS portion to the transmitting device for Wi-Fi sensing; and
the reconfigurable metasurface MCU to wirelessly report the detected beamforming phase shift or location information of the target object to the transmitter device conducting Wi-Fi sensing.

16. The reconfigurable metasurface unit cell array of claim 15 further comprising:
the reconfigurable metasurface unit cells including plural metasurface reconfigurable split rings with corresponding refractory heaters to switch the corresponding metasurface reconfigurable split ring between a conductive state and dielectric state to switch the adjustable capacitance of the reconfigurable metasurface unit cell; and
and the reconfigurable metasurface MCU to selectively provide power to some portion of the plural refractory heaters to change the electromagnetic reflective properties of the array of reconfigurable metasurface unit cells to conduct the beamforming.

17. The reconfigurable metasurface unit cell array of claim 15 further comprising:
the reconfigurable metasurface MCU to execute computer-readable program code of a NLoS sense signal phase backscatter system to create a modulated signal within a backscatter signal sent back to the transmitter device to report the detected beamforming phase shift or location of the object to the transmitter device.

18. The reconfigurable metasurface unit cell array of claim 15 further comprising:
the reconfigurable metasurface MCU to establish a side band communication with the transmitter device, via a reconfigurable metasurface antenna and radio, to report the detected beamforming phase shift or location of the object to the transmitter device.

19. The reconfigurable metasurface unit cell array of claim 15 further comprising:
the detected CSI characteristics including channel impulse response data describing how an impulse signal transmitted by the transmitter device and relayed by the reconfigurable metasurface unit cell array propagates through a channel along the virtual LoS portion of the wireless link for details related to delay spread, multipath components, and amplitude.

20. The reconfigurable metasurface unit cell array of claim 15 further comprising:
a metasurface controller field programmable gate array (FPGA) to access a look-up table defining how the metasurface controller FPGA is to instruct switching of adjustable capacitance of the plurality of reconfigurable metasurface unit cells in the reconfigurable metasurface unit cell array to create destructive or constructive interference to create directionality and feed distance as the EM wave is reflected towards the target object to conduct beamforming.
